(19) United States
(12) Patent Application Publication
(10) Pub. No.: US 2010/0186400 A1
(43) Pub. Date: Jul. 29, 2010

(54) Method, system and computer program product for producing renewable electrical power

(76) Inventors: Robert B. Preston, Manchester, CT (US); Richard A. Mitchell, Southington, CT (US)

Correspondence Address: Richard A. Mitchell, Esq.;Beacon Industries, Inc., 85 Granby Street, Bloomfield, CT, 06002, US

(21) Appl. No.: 12/592,148

(22) Filed: Nov. 19, 2009

Related U.S. Application Data
(60) Provisional application No. 61/205,936, filed on Jan. 26, 2009.

(51) Int. Cl. F03G 7/00; F03B 17/04

(52) U.S. Cl. 60/325; 415/916

(57) ABSTRACT

A system, method and computer program product for producing renewable electrical power energy which does not require the consumption of fossil-based, petroleum-based or other combustible fuels, nor release hazardous emissions or byproducts to the atmosphere or otherwise to the environment. The system utilizes closed-loop fluid recirculation and is not dependent upon an external unlimited sources of water flow and head as with dam-style hydro-electric power systems and is not dependant upon predefined favorable environmental and/or weather conditions to function. The system includes a DC magnetic system adapted to be coupled between an AC generator and a hydro-rotor/centrifugal pump system; a DC power source and charging system; a propulsion pump system; and a containment housing with a plurality of thrust producing vanes, fluid management infrastructure and reservoir. The hydro-rotor/centrifugal pump system utilizes thermal energy, kinetic energy, fluid dynamics, mass inertia and centrifugal forces to drive an AC electrical generator, and the DC magnetic system serves to both initiate the system and regulate the electrical output of the generator.

### CROSS-REFERENCE

This application claims the benefit of U.S. Provisional Application No. 61/205, 936 filed on Jan. 26, 2009.

### FIELD OF THE INVENTION

The present invention generally relates to renewable or auxiliary electrical power devices. More particularly, the present invention relates to a method, system and computer program product for producing renewable electrical power with a closed-loop system device which does not require the combustion or consumption of fuels or other external power/fuel sources to function. The system utilizes a DC magnetic system to initiate and regulate the speed of a closed-loop hydro-rotor/centrifugal pump system and ultimately the electrical output of an AC generator. This is accomplished by monitoring the AC electrical power output and speeding up or slowing down the rotation of the hydro-rotor/centrifugal pump system. The speed of the rotation of the hydro-rotor/centrifugal pump system is controlled by varying the DC voltage and magnetic fields. The DC power depleted from the battery source is replaced through a conversion of a very small percentage of the AC electrical power output to DC.

### BACKGROUND OF THE INVENTION

### Brief Description of the Related Art

Over the years, systems have been developed to provide stand-by, auxiliary and remote location electrical power solutions such as gasoline or diesel generator sets, solar panels, wind turbines and fuel cells. Each of these systems has inherent limitations however. Gasoline and diesel generator sets require a constant supply of combustible fuel and by design produce emissions which are hazardous to the environment. Alternatives such as solar panels and wind turbines are by design dependent upon a minimum source of favorable environmental factors and conditions, namely sunlight ultraviolet rays and wind, in order to function, and conventional fuel cells release hydrogen into the atmosphere.

Each of these systems also has unique, specific and unyielding dimensional space and installation footprint requirements which further serve as system limitations in practical applications. Further, the environmental impact of these various conventional systems goes far beyond the hydrocarbon and carbon monoxide emissions of the generator sets. Each solar, wind turbine and fuel cell device and system has likewise come under the attack of environmentalists and other “not in my back yard” lobbyists.

Traditional hydro-electric power generation systems harness the elevation head, the velocity head and the elastic potential energy of water to generate electric power. The prominent hydro-electric power plants are sited on great natural waterways. The building of dams and the elevating of the water surface in order to provide the stored volume and increase the elevation head of the waterway constitute the main features of our present day hydro-power systems. The single energy input is the natural gravitational force induced elevation head which is transformed either into velocity head to run an impulse turbine or into pressure head to run a reaction turbine. The single output is converted into electrical energy. This conventional hydro-power has no input in the form of electrical energy. Hydro-power is recognized as clean, relatively economical due to the use of water provided by Mother Nature through the water cycle, and free of fossil fuel detrimental environmental effects.

However, hydro-electric power plants have their limitations and shortcomings. First, it is available only to geographic sites where there are big natural waterways. The distance between these sites and the cities demanding the power typically requires the use of long transmission lines with inherent losses. Second, the operation of the hydro-electric power plant is entirely dependent upon the seasonal precipitation; thus the annual outputs are only a fraction of the installed design capacities. Third, constructing dams by definition changes and affects the land use above and below the dam and can carry heavy social costs. Fourth, the construction time of a dam is extremely long. Fifth, the required site preparation, alteration and extensive civil works are quite expensive. Sixth, the maintenance includes upstream debris removal, sedimentation removal works and complicated and tedious turbine maintenance. Finally, there is always a threat of dam failure that could result in catastrophic consequences to lives and properties.

Many systems have been designed with the intent to overcome the inherent limitations and drawbacks of conventional hydro-electric power plants. U.S. Pat. No. 6,420,794 issued to Cao disclosed a scheme of employing a delivering reservoir, a receiving reservoir and a back-up reservoir in which the water is circulated, and an elaborate valve system that maintains the level of water to drive hydro-turbines. U.S. Pat. No. 6,388,342 issued to Vetterick, Sr. et. al. advances a hydro-electric plant which includes an apparatus and method for converting renewable wave action energy to electrical energy that harnesses fluid wave power by employing a plurality of low-mass buoys floating on a fluid surface connected to low volume pumps. The pumps transfer fluid from a source to an elevated storage tank. The elevated tank serves as a reserve source of fluid that then flows by gravity to drive a hydro-electric generator thereby creating an electrical current. While this system harnesses renewable wave energy, it still does not address many of the inherent limitations of the traditional hydroelectric power plant.

U.S. Pat. No. 4,965,998 issued to Estigoy et. al., addresses some of the dependence on natural water precipitation limitations by providing a pump, secondarily driven by the generator driving turbine, which recycles the water discharged from the turbine back to the reservoir. There have been many derivatives of this scheme advanced by others as well. However, the law of conservation of energy teaches us that energy cannot be created nor destroyed; but can be transformed, transferred, accumulated, stored and either be harnessed for constructive use producing usable electrical energy or be converted into various dissipated forms. Thus, given it requires the same amount of energy to pump the fluid back up to the elevation that represents the starting quantum of potential kinetic energy, in addition to the energy losses in the turbine, generator and pump, it is suspect that additional energy can be transferred to electrical power by a hydro turbine which is simultaneously powering an electrical generator. Such a device was also claimed in PCT WO 2009/077662 A2 issued to Tiltay of France.

The aim of the present invention is to overcome some of prior art shortcomings cited above. The present invention comprises unique features and equipment which is configured to takes advantage of three known laws of Mechanical Energy, Thermal Energy and Kinetic Energy, while also comprising the elements and knowledge of Inertia, Fluid Dynamics and Harmonic Frequencies. The present invention is novel in that it utilizes the mass of a rotating rotor to create a self-sustaining centrifugal pump to re-circulate the fluid and dynamically raise the operating head. Another novel and useful feature of the present invention is its inherent tolerance of external AC electrical system loads due to the spinning inertia mass of the rotor. Some of the conventional power sources such as generator sets are not inherently tolerant of external system loading. These power sources must employ significant voltage regulation circuitry and cost in an attempt to avoid unwanted over-cycling or “hunting” of the engine combustion system relative to the desired constant rotational input required by the AC Generator being driven.

Accordingly, an object of the present invention is to provide a novel method, system and computer program product for producing renewable electrical power energy in a more environmentally friendly manner as compared to many of the conventional methods and systems. It is another object of the present invention to provide such renewable electric power energy without dependence upon external unlimited sources of water flow and head as with dam-style hydro-electric power systems, and further, not being dependant upon predefined “favorable” environmental and/or weather conditions to function. It is yet another object of the present invention to provide such renewable electric power energy without dependence upon a continual supply of a combustible fuel.

### SUMMARY OF THE INVENTION

The objects of the present invention stated above and still other objects in the field of the invention are achieved according to the present invention by providing a novel system, method and computer program product for producing renewable electrical power energy. The system includes a DC magnetic system adapted to be coupled between an AC generator and a hydro-rotor/centrifugal pump system; a DC power source and charging system; a propulsion pump system; and a containment housing with a plurality of thrust producing vanes, fluid management infrastructure and reservoir. The hydro-rotor/centrifugal pump system utilizes thermal energy, kinetic energy, fluid dynamics and mass inertia to drive an AC generator. The DC magnetic system serves to both initiate the system and regulate the electrical output of the generator by controlling the rotational speed of the hydro-rotor/centrifugal pump system.

A DC voltage regulator circuit monitors the generator AC electrical power output and correspondingly raises or lowers the DC voltage applied to the DC magnetics system thereby dynamically varying the magnetic field in order to speed up or slow down the rotation of the hydro-rotor/centrifugal pump system. The DC power depleted from the battery source to power the magnetic fields is replaced through a conversion of a very small percentage of the AC electrical power output back to DC. Thus, the DC power circuit and the recirculation of the system operating fluid represent closed-loop systems, thereby enabling a complete assembly of a preferred embodiment of the present invention, referred to herein as the Electronic Hydropod system, to be a self-sustainable renewable energy source. An alternative embodiment of the present invention utilizes an AC powered drive system in lieu of the DC magnetics system.

The Electronic Hydropod system is a compilation and integration of the three known laws of Mechanical Energy, Thermal Energy and Kinetic Energy, while also comprising the elements and knowledge of Inertia, Fluid Dynamics and Harmonic Frequencies. Also, as known, E=mC² (energy equals mass, times the speed of light, squared). In the present invention, tests of “m” (mass) were performed by using “weight” (W) as an appropriate substitute for mass. Since mass has weight here on earth, “m” can be represented as mass times weight (m×W). Then, E=mWC². This principle is important in the understanding of the efficiencies of the closed-loop hydro-rotor/centrifugal pump system, referred to herein as the hydropod system. (Note, the Electronic Hydropod system includes the hydropod system coupled to a control mechanism for controlling the rotational speed of the hydropod system). One of the unique features and benefits of the present invention is based in the fluid capillary (or siphon) phenomenon caused by the spinning hydro-rotor centrifugal forces. This capillary action draws fluid up to feed a plurality of propelling jet-streams, in effect raising the head of the fluid system and thereby making the propulsion system extremely efficient and supplementing the self-sustaining nature of the system.

### BRIEF DESCRIPTION OF THE DRAWINGS

FIGS. 1A and 1B are illustrations of the major sub-sections/sub-systems of the Electronic Hydropod system according to the present invention.

FIG. 2 depicts the four major sub-systems and assemblies within the hydropod system

FIG. 3 is an illustration of the various sub-components and sub-systems of the Electronic Hydropod system according to the present invention.

FIG. 4 is a block diagram of a closed-loop renewable energy device according to the present invention.

FIG. 5 is a conservation of energy and system logic block diagram of a renewable energy device according to the present invention.

FIG. 6 is a schematic illustration of a general purpose microprocessor-based or digital signal processor-based system which can be programmed according to the teachings of the present invention.

### DESCRIPTION OF THE PREFERRED EMBODIMENT

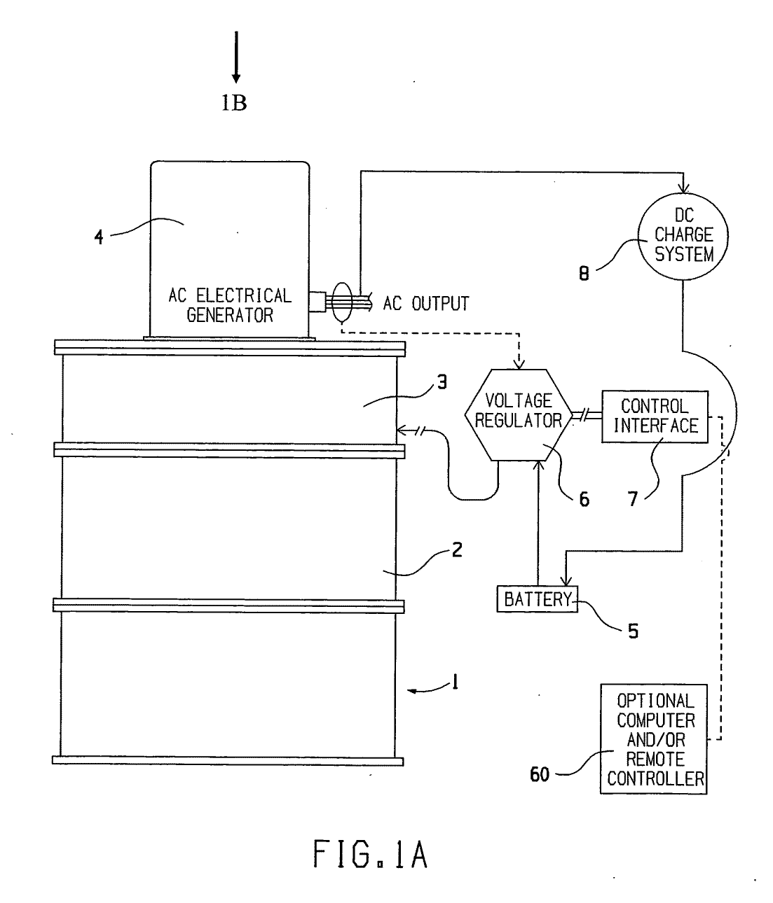

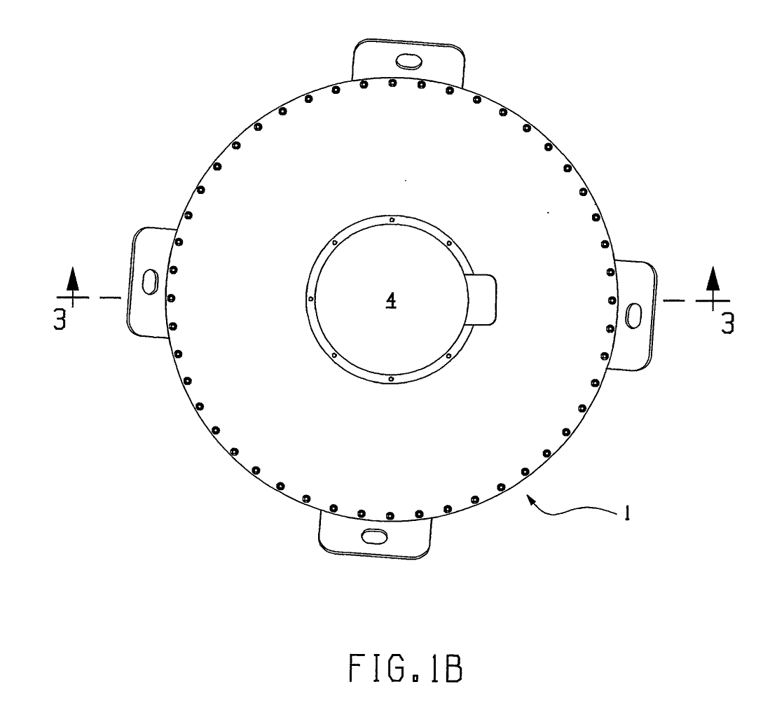

Referring now to the drawings, wherein like reference numerals designate identical or corresponding parts throughout the several views, and more particularly to FIGS. 1-6 thereof, there are shown various embodiments of the present invention, as will now be described.

FIG. 1A and FIG. 1B depict the major elements of the closed-loop renewable energy system. In FIG. 1A, the Electronic Hydropod system 1 comprises: the Hydropod system 2, the hydro-power section of the device; the DC magnetics drive system 3; an AC electrical generator 4; a DC battery or other DC power source 5; the DC magnetics system voltage regulator 6; the control interface system 7; and a DC charging system 8 to convert a small percentage of the AC electrical generator output to DC to recharge the DC battery 5 back to full capacity. Also depicted is an optional computer and/or remote controller system 60.

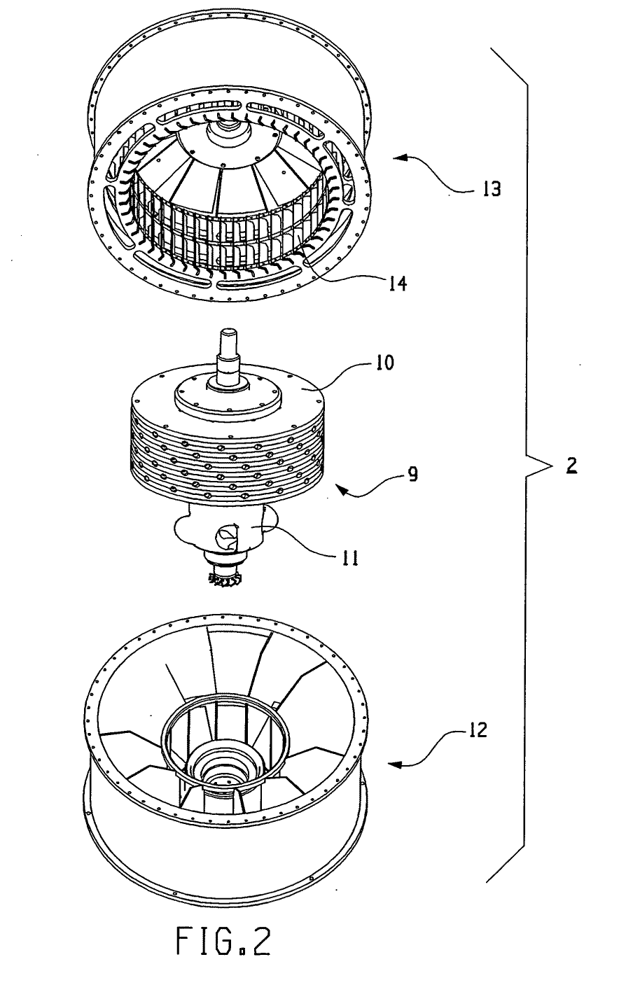

FIG. 2 depicts the four major subsystems and assemblies within the hydropod system 2: a hydro-rotor/centrifugal pump assembly 9, also referred to herein as the “hydro-rotor assembly”, comprising a “hydro-rotor” 10 with substantial mass and a plurality of high-pressure nozzles, and a propulsion system 11 comprising a screw pump system and integral lower rotor support shaft which provides fluid flow to a central cavity in the hydro-rotor 10 to feed the various nozzles; a containment housing comprising a lower section 12, which serves as the reservoir for the fluid media and comprises a bearing support means to support the hydro-rotor assembly 9 and system of gussets which provide structural integrity as well as serves as fluid management diffusers to channel the fluid to the propulsion system 11; and an upper containment housing section 13, which incorporates jet-stream deflector devices commonly referred to as vanes or blades and referred to herein as thrust vanes 14, and support infrastructure, fluid management provisions, bearing support for the top of the hydro-rotor assembly 9 and a system of gussets which likewise provide structural integrity as well as serves as fluid management diffusers to channel the fluid back to the reservoir.

The fundamental way of thinking about or understanding how the hydropod system works is to first consider the two complimentary principals of centrifugal force and mass in motion, or inertia. It is helpful to draw an analogy to other devices or systems employing the principal of centrifugal forces in hydraulic or fluid systems. Consider for example, the common clothes washing machine in the spin cycle. By spinning the washing machine basin at a high rate of speed, and by virtue of its inherent mass, the residual water is slung radially outward away from the center of rotation and wicked from the clothes. Correspondingly, when a toy top is spun very quickly about its main axis, its inherent mass or weight maintains the rotation of the top for an extended period of time. However, the laws of physics prevent the top from spinning into perpetuity.

The friction placed upon its point from contact with the surface on which it rotates, and the friction about its entire outer profile caused by air drag, eventually absorb enough of the kinetic energy that was temporarily stored in the top and it topples. Similarly, point-of-contact friction and air friction forces are at play when a basketball is spun quickly and balanced on one's finger tip. While it requires a sudden and substantial rotational force to be applied to the basketball to establish its rotation, once achieved, it only requires periodic and comparatively low inputs of fanning “taps” applied to the side of the basketball to overcome these combined frictional losses and thereby sustain the rotation of the ball on the fingertip. The known principal of Conservation of Energy dictates that one only need replace the kinetic energy that was transferred into friction losses or other energy losses in order to sustain rotation.

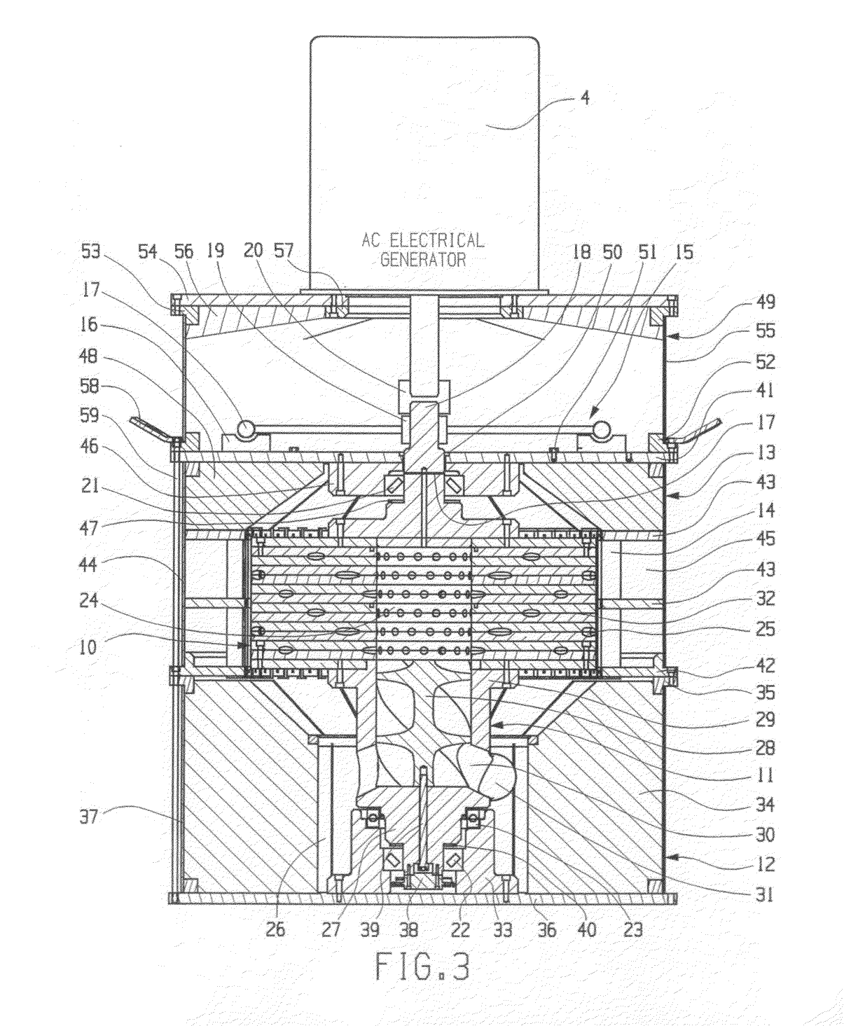

FIG. 3 depicts the various sub-systems and sub-components within the present invention. When the system is initiated via manual, automatic or remote turn-on command, DC voltage is applied to the DC magnetics system 15 fixed DC magnets 16 creating a magnetic field causing the DC armature 17 to rotate about an axis central to the hydropod system 2. The DC magnetics system 15 comprises a large diameter which optimizes the thrust and torque generating capability applied to a central shaft/drive mechanism (hydro-rotor “top shaft”) 18 affixed to the hydro-rotor 10 via a mechanical coupling 19. The rotational torque of the DC magnetics system armature is transferred to the hydro-rotor assembly causing it to rotate about its axis and gradually increase to the prescribed AC electrical generator 4 speed, such as 1800 rpm. The hydro-rotor top shaft 18 is coupled to the AC electrical generator 4 drive shaft via a typical drive train style mechanical coupler 20 and thus the AC electrical generator 4 rotates at the same speed as the entire hydro-rotor/centrifugal pump assembly 9 (also referred to as “hydro-rotor assembly” herein). Once rotating at 1800 rpm, the hydro-rotor 10 and its considerable mass serves as a tremendous source of kinetic energy and the system need only replace the energy lost to friction and other anti-rotational forces.

To counter these losses, sustain rotation of the hydro-rotor assembly 9 and ultimately drive the AC electrical generator 4, and replace the system energy losses, the present invention employs four sub-systems: the propulsion system 11, the hydro-rotor 10, the DC magnetics system 15, and various low friction bearing systems 21, 22 and 23. There are numerous combinations, styles and quantities of possible bearing systems recognized as applicable to the present invention (e.g., static bushings, dynamic mechanical bearings, electronic or electrical bearings, etc.); thus, those depicted in FIG. 3 are merely representative examples. The propulsion system 11 is responsible for furnishing the center cavity 24 of the hydro-rotor 10 with a constant source of fluid flow and pressure, and works in conjunction with the hydro-rotor's 10 plurality of high pressure nozzles 25 and corresponding container 13 stationary thrust vanes 14 to produce hydraulic thrust.

The DC magnetics system 15 has two principal purposes. First, it is responsible for initially powering the hydro-rotor 10 and propulsion system 11 up to design speed at which time the centrifugal forces of the hydro-rotor 10 produce multiple high pressure nozzle 25 jet-streams to create rotational thrust by pushing off of the stationary thrust vanes 14 and the mass of the hydro-rotor 10 creates extremely high inertia and corresponding stored kinetic energy. Second, once the design rotational speed is achieved, such as with an AC electrical generator 4 shaft design speed of 1800 rpm, a DC voltage regulator 6 reduces the voltage being applied to the DC magnetics system magnets 16 to reduce the power of the DC magnetic fields until either the hydro-rotor assembly 9 kinetic energy and inertia sustain the design speed on their own, or a low level of DC voltage is required to assist in maintaining the design speed. Thereafter, the DC voltage regulator 6 will monitor the output of the AC electrical generator 4 and apply only the DC voltage necessary to replace any hydro-rotor assembly 9 energy losses, i.e., the proportionate rotational “taps” in the spinning basketball analogy.

The fourth system is dedicated to minimizing system energy losses, thus lowering the demand for DC voltage and magnetics assistance and raising the overall efficiency of the Electronic Hydropod system. As stated, while many combinations are possible, FIG. 3 demonstrates one of the preferred embodiments of the present invention. It comprises a plurality of high quality precision roller bearings 23 and tapered roller bearings 21 and 22 to support the hydro-rotor/centrifugal pump assembly 9 and sustain efficient rotational center with minimal friction losses. The entire hydro-rotor assembly 9 is also precision-balanced during manufacture and assembly. In addition, at design speed, the hydro-rotor assembly 9 centrifugal pump function serves to shift the head of the dynamic fluid system from the lower reservoir 26 up to the spinning hydro-rotor 10 which serves to cause the spinning hydro-rotor 10 to approach weightlessness, thereby further reducing frictional losses in the bearings 21, 22 and 23.

While the hydro-rotor assembly 9 is rotating, the propulsion system 11 is constantly feeding pressurized fluid flow from the reservoir 26 to the hydro-rotor center cavity 24. In the preferred embodiment, the propulsion system 11 employs an integrated multifunctional pumping system which simultaneously functions as the hydro-rotor 10 rotational bottom support shaft 27. The propulsion system 11 comprises a screw pump 28 which is centrally and axially located inside of and fixed to an integrated screw pump outer cylinder 29 such as with bolt 39 and/or axial and radial pins. In the preferred embodiment, the screw pump outer cylinder 29 has four fluid flow passages 30 aligned with the working area between each of the four screw pump 28 impeller blades. Numerous configurations and quantums of screw pump 28 blades could be utilized. The screw pump outer cylinder 29 also comprises a concave scooping geometry 31 adjacent to each of the four fluid passages. These scoops 31 are so shaped and aligned so as to efficiently push fluid in the reservoir 26 up into the screw pump 28 where the fluid is then conveyed upward into the hydro-rotor 10 center cavity 24.

The hydro-rotor 10 in the preferred embodiment is comprised of either a single or a stacked plurality of individual hydro-rotor disks 32. As each rotor disk 32 has fluid channels that connect the hydro-rotor center cavity 24 to the outer diameter nozzles 25, these hydro-rotor disks 32 may be comprised of two opposing mirror image halves for ease of manufacture purposes and then bolted or otherwise affixed together to form the fluid channels. In the stacked hydro-rotor plurality shown in FIG. 3, the hydro-rotor center cavity 24 fluid channel inlets and corresponding nozzle 25 jet-stream outlets are staggered in relation to the vertical rotational axis. This arrangement minimizes the contact period between nozzle 25 jet-streams and the vanes 14 to maximize the thrust capability at all times while distributing the load concurrently to many vanes 14.

The fluid gathered and pressurized inside the hydro-rotor center cavity 24, which is spinning at 1800 rpm, is pushed outward by centrifugal forces through the respective fluid channels. The performance and efficiency of the jet-streams produced can be improved by modifying the fluid channels to gradually decrease the channel diameters as the channel approaches the outside diameter of the hydro-rotor disks 32 thereby increasing the effective velocity of the jets-stream. Alternately, or in conjunction with varying the fluid channel effective diameter, specifically configured nozzles 25 can be installed at the fluid channel outside diameter outlets to increase the working velocity of the jet-streams.

The unique and novel centrifugal slinging forces created by the spinning hydro-rotor 10, while being fed a constant source of fluid by the propulsion system 11, results in tremendous siphon pulling forces being applied back on the hydro-rotor center cavity 24 by each of the plurality of jet-streams. This is analogous to the conventional siphon application where atmospheric pressure applies a force on the surface of a reservoir and forces fluid through a hose which rises above the surface of the reservoir and is then provided with an outlet below the surface of the reservoir. Conventional wisdom tells us that the water will continue to flow. This principal, together with the tremendous inertial benefits of the rotating hydro-rotor 10 mass is what effectively raises the head within the system and allows the system to sustain its electrical generator 4 driving rotation with very little external application of energy by the DC magnetics drive system.

The containment housing is constructed in modular sections for both ease of manufacture and to enhance structural integrity of the container during both operation and transport of the system. The lower container section 12, which serves as the reservoir 26 for the fluid media, also comprises a bearing support means 33 to support the bearings 22 and 23 which support the hydro-rotor bottom shaft 27, and a system of gussets 34 which provide structural integrity as well as serve as fluid management diffusers to direct and channel the fluid to the propulsion system. The lower container section 12 has an upper structural flange 35, a structural base plate 36 and a cylindrical outer wall 37. To improve the circulation of fluid through the bearings 22 and 23 which support the hydro-rotor bottom shaft 27, fluid passages are present in the bearing support means 33 which allow fluid to flow from the outside diameter or the bearing support means 33 to its inside cavity where the bearings 22 and 23 are installed. To still further improve the efficiency, lubrication and cooling of the bearings 22 and 23, an optional impeller 38 may be secured to the hydro-rotor bottom shaft 27 which creates a vacuum and corresponding suction to draw the fluid through the bearing support means 33 and then direct and convey the fluid up through the bearings 22 and 23. To further ensure that the system loads are appropriately distributed to the bearings 22 and 23, a spacer shim 40 may be customized to precision thickness.

The hydropod 2 top containment housing section 13 has an upper structural plate 41 which also serves as a mounting flange for the DC magnetics containment section 49, a structural bottom flange 42, two intermediate vane support rings 43 and a cylindrical outer wall 44. The intermediate vane support rings 43 position the thrust vanes 14 relative to the nozzle 25 jet-streams and transfer these thrust loads to the outer container wall 44. The vanes 14 can be flat, convex or concave, however in the preferred embodiment, the thrust vanes 14 have the contact surface skewed to the angle of the jet-stream and include a convex angle. After the initial contact thrust period, the continuing rotation of the hydro-rotor causes the jet-streams to impact beyond the thrust vane 14 bend on the convex surface which serves to direct the fluid flow away from the particular thrust vane 14 as well as adjacent thrust vanes 14 so as to not interfere with the efficiency of the jet-stream thrust. The intermediate vane support rings 43 further include fluid management passages and provisions which enable the fluid after impact with the vanes 14 to be efficiently directed back to the reservoir 26 through the fluid management channel 45 between the vanes 14 and the outer wall 44.

In alternate embodiments, the thrust vanes 14 can be position at skewed angles rather than parallel to the axis of the hydro-rotor assembly 9 axis. In still further alternative embodiments, the thrust vane 14 position and orientation relative to the rotating hydro-rotor assembly nozzles 25 may be adjustable for optimum hydro performance. For instance, provisions can be included to remotely adjust the thrust vanes 14 position and orientation relative to the rotating hydro-rotor assembly 9 and nozzle 25 jet-stream vectors for optimum thrust generation and dynamic hydro performance at various hydro-rotor assembly 9 rotational speeds. Such remote thrust vane 14 position and orientation adjustment can be accomplished via a mechanical linkage system similar to any conventional pivoting louvered system, or may be accomplished via an electro-mechanical and/or servo-controlled system similar to a jet/turbine engine exhaust thrust vector control system, among others.

Similar to the bottom containment housing section 12, the top containment housing section 13 includes a bearing support means 46 for the hydro-rotor top shaft bearing 21. To improve the circulation of fluid through the bearing 21 which supports the hydro-rotor top shaft 18, fluid passages are present in the hydro-rotor top shaft 18 which allow fluid to flow from the pressurized hydro-rotor center cavity 24 to the top of the top shaft bearing 21. To further ensure that the system loads are appropriately distributed to the top shaft bearings 21, and to accommodate and adjust for manufacturing tolerance stack-ups, a spacer shim 47 may be customized to precision thickness and positioned adjacent to the top shaft bearing 21. The top containment housing section 13 also includes a system of gussets 48 which likewise provide structural integrity as well as serve as fluid management diffusers to channel any fluid above the hydro-rotor 10 back to the reservoir 26 via the fluid management channel 45 between the thrust vanes 14 and the outer wall 44.

In order to prevent the operating fluid from escaping the hydropod 2 and contaminating the DC magnetics section 15, the top plate 41 is fitted with a top shaft seal 50 at the interface to the rotating hydro-rotor top shaft 18. The top plate 41 is also fitted with either a single or a plurality of breathers 51 which allow air into the hydropod 2 to facilitate unrestricted fluid flow and allow the fluid to efficiently return principally via gravity to the reservoir 26. The breathers 51 include a screen mesh or other provisions to prevent the operating fluid from escaping from the hydropod container top housing 13 while allowing air in.

The DC magnetics drive system 15 is installed on top of and affixed to the hydropod 2 top containment housing section 13 and protected by the containment section 49. Containment section 49 includes a bottom flange 52 for mounting to the hydropod 2 top containment housing section top plate 41, a top mounting flange 53 for securing a removable electrical generator mounting plate 54, and an outer wall 55. To further support the weight of the electrical generator 4, a gusset system 56 similar in geometry to the gussets utilized in the hydropod 2 is affixed between the outer wall 55 and a gusset support ring 57 which is centrally positioned about the common rotating axis of the hydro-rotor assembly 9 and electrical generator 4.

FIG. 3 also depicts a plurality of lifting brackets 58 which are positioned about the outside perimeter of the Electronic Hydropod container and affixed either at the structural flanges of the hydropod upper container top plate 41 and the DC system containment section lower flange 52, or at the structural flanges of the hydropod upper container lower flange 42 and the bottom container top flange 35, in order to be above the center of gravity of the system for safe lifting and transport. Also depicted is a scheme for optional lifting tie-bars 59 which can be utilized to transfer the system weight lifting load from the lifting brackets 58 down to the structural floor plate 36 rather than through the outer walls 37 and 44. Other lifting and transport means such as forklift tine pockets could also be utilized.

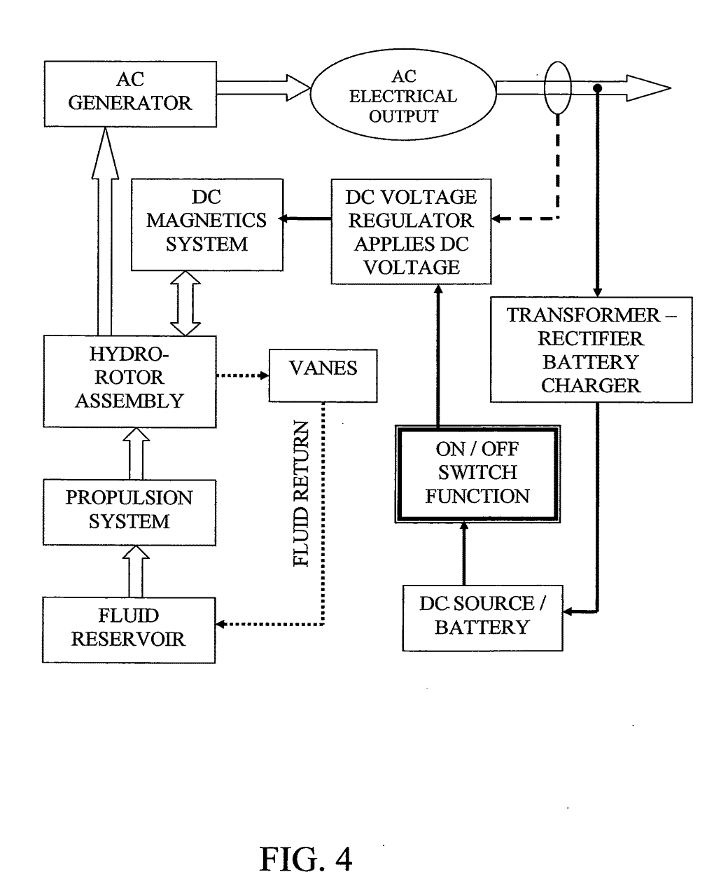

FIG. 4 is a block diagram of a closed-loop renewable energy device according to the present invention. The DC voltage regulator circuit constantly monitors the generator AC electrical power output and correspondingly raises or lowers the DC voltage applied to the DC magnetic system thereby dynamically varying the magnetic field in order to speed up or slow down the rotation of the hydro-rotor/centrifugal pump system. The DC power depleted from the battery source to power the magnetic fields is replaced through a conversion of a very small percentage of the AC electrical power output back to DC via a traditional transformer/rectifier battery charging system. Thus, the DC power circuit and the recirculation of the system operating fluid represent closed-loop systems.

The output of the electrical generator is monitored by a voltage regulator circuit which then automatically applies the appropriate DC voltage to the DC magnetic system coils in order to maintain the hydro-rotor rotational speed within a specified generator operating speed such as but not limited to 1800 rpm. The DC magnetics system may comprises a plurality of poles with corresponding electrical coils, and fixed permanent or electronic magnets and corresponding coils, such that when a DC voltage is applied it produces a rotational force capable of developing sufficient torque to rotate the hydro-rotor assembly to the predetermined speed. The means for varying the DC voltage applied to the DC magnetics system manipulates the DC magnetic field so as to slow down or speed up as required the rotational speed of the hydro-rotor assembly. This means may also generate drag and reversing rotational torque sufficient to aid in bringing the hydro-rotor assembly to a halt. The DC power source may comprise any number of commercially available or specifically configured batteries designed for deep cycle operation, or a plurality of such batteries.

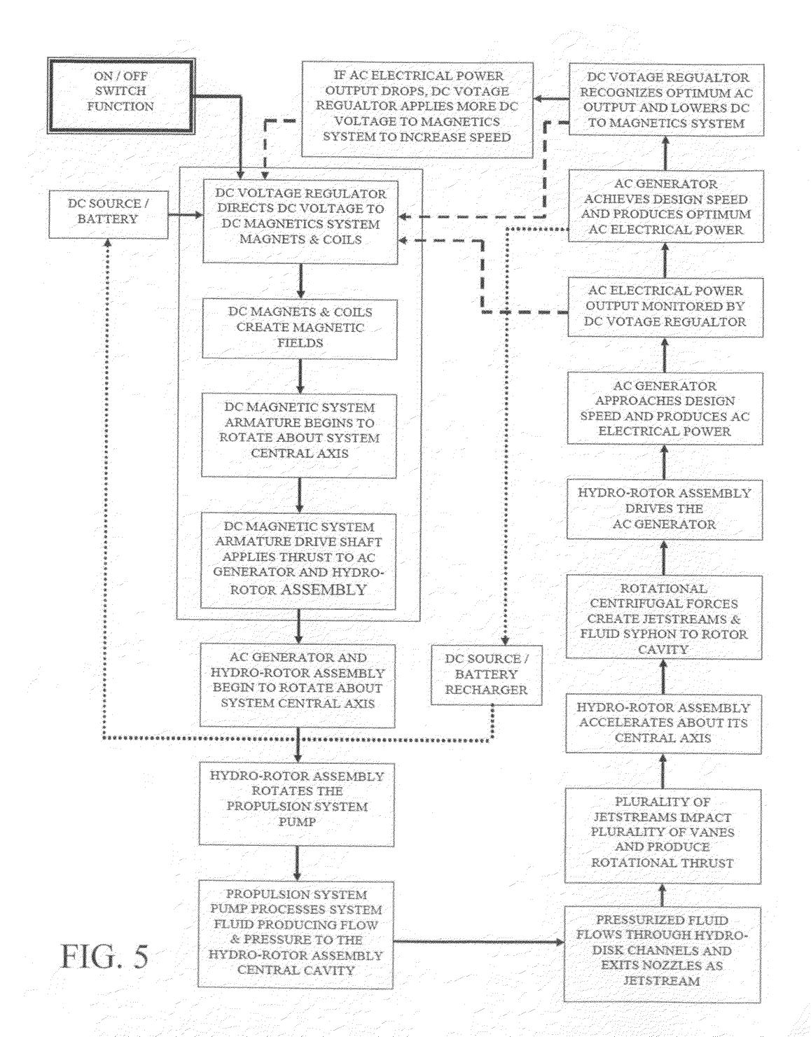

FIG. 5 is a conservation of energy and system logic block diagram of a renewable energy device according to the present invention. When DC voltage is applied to the DC magnetics drive system, a rotational thrust is created and applied to commence rotation of the hydro-rotor assembly. The moment the hydro-rotor assembly begins to spin, the accumulation of useable system energy and hydronics (fluid hydraulics) begins to form. The unique and novel centrifugal slinging forces created by the spinning hydro-rotor, while being fed a constant source of fluid by the propulsion system, results in tremendous siphon pulling forces being applied back on the hydro-rotor center cavity by each of the plurality of jet-streams. This principal, together with the tremendous inertial benefits of the rotating hydro-rotor mass, is what effectively raises the head within the system.

By virtue of the low friction systems employed, very little additional or “external” energy is needed for the system to continue spinning and allows the system to sustain its electrical generator driving rotation. The output of the generator is then monitored to detect a drop in AC voltage output and determine when to apply additional DC voltage and how much DC voltage needs to be applied to sustain the specified speed, such as 1800 rpm. The specialized containment of the system allows the system to virtually eliminate friction, drag and fluid conflagration. The mass, velocity and weight of the fluid accumulates on the outer portion of the rotor at the nozzles ready to transfer its energy into rotational thrust. The utility of these events—kinetic energy (energy due to mass and motion), potential energy (energy due to position and speed), and thermal energy (work and heat)—in combination with the centrifugal forces and fluid siphoning phenomenon, and the inherently low system drag or friction losses, allows the system to efficiently transform all of these energy sources in electrical power.

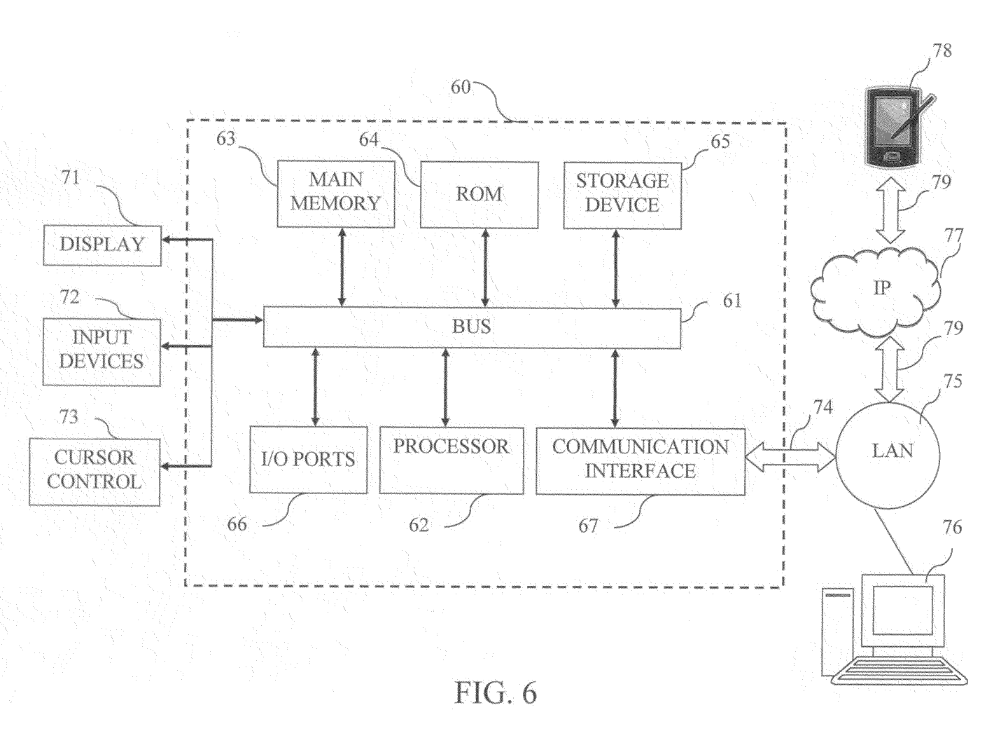

FIG. 6. illustrates a computer program product comprising computer system 60 (e.g. corresponding to the optional computer and/or remote controller 60 on FIG. 1A.) upon which the present invention may be implemented. The computer system 60 maybe any one a personal computer, a work station computer system, a lap top computer system, an embedded controller system, a microprocessor-based system, a programmable logic controller (PLC), a digital signal processor-based system, a hand held device system, a personal digital assistant (PDA) system, a wireless system, a wireless networking system, etc. The computer system 60 includes a bus 61 or other communication mechanism for communicating information and a processor 62 couples with bus 61 for processing the information.

The computer system 60 also includes a main memory 63, such as a random access memory (RAM) or other dynamic storage device (e.g. dynamic RAM (DRAM), static RAM (SRAM), synchronous DRAM (SDRAM), flash RAM), coupled to bus 61 for storing information and instructions to be executed by processor 62. In addition, main memory 63 may be used for storing temporary variables or other intermediate information during execution of instructions to be executed by processor 62. Computer system 60 further includes a read only memory (ROM) 64 or other static storage device (e.g. programmable ROM (PROM), erasable ROM (EPROM), and electrically erasable PROM (EEPROM)) coupled to bus 61 for storing static information and instructions for processor 62. A storage device 65, such as a magnetic disk, optical disk or solid state disk (SSD), is provided and coupled to bus 61 for storing information and instructions.

The computer system 60 also includes input/output ports 66 to couple the computer system 60 to the Electronic Hydropod system control interface 7 or otherwise to the electronic hydropod system 1 to effectuate automatic control thereof, as previously described with respect to FIG. 1A. Such coupling may include direct electrical connections, wireless connections, networked connections, etc., for implementing automatic control functions, remote control functions, etc.

Computer system 60 may also include special purpose logic devices (e.g., applications specific integrated circuits (ASICs)) or configurable logic devices (e.g. generic array of logic (GAL) or re-programmable field programmable gate arrays (FPGAs)). Other removal media devices (e.g., a compact disk, a tape, and a removable magneto-optical media) or fixed, high density media drives, may be added to the computer system 60 using an appropriate device bus (e.g., a small computer system interface (SCSI) bus, an enhanced integrated device electronics (IDE) bus, or an ultra direct memory access (DMA) bus). The computer system 60 may additionally include a reader-writer flash memory unit, reader-writer digital video disk (DVD) unit, reader-writer Blu-ray disk (BD) unit, reader-writer compact disk (CD) unit, or a compact disc jukebox, each of which may be connected to the same device bus or another device bus.

The computer system 60 may be coupled via bus 61 to display 71, such as a cathode ray tube (CRT), liquid crystal display (LCD), plasma display, voice synthesis and/or software, etc., for displaying and/or providing information to a computer user. The display 71 may be controlled by a display or graphics card. The computer system includes input devices, such as a keyboard 72 and a cursor control 73 for communicating information and command selections to processor 62. Such command selections can be implemented via voice recognition hardware and/or software functioning as the input devices 72. The cursor control 73, for example, is a mouse, a trackball, cursor direction keys, touch screen display, optical character recognition hardware and/or software, touchpad hardware and/or software etc., for communicating direction information and command selections to processor 62 and for controlling cursor movement on the display 71. In addition, a printer may provide printed listings of the data structures, information, etc., or any other data stored and/or generated by the computer system 60.

The computer system 60 performs a portion or all of the processing steps of the invention in response to processor 62 executing one or more sequences of one or more instructions contained in a memory, such as the main memory 63. Such instructions may be read into the main memory 63 from another computer readable medium, such as storage device 65. One or more processors in a multi-processing arrangement may also be employed to execute the sequences of instructions contained in main memory 63. In alternative embodiments, hand-wired circuitry may be used in place of or in combination with software instructions. Thus, embodiments are not limited to any specific combination of hardware circuitry and software.

As stated above, the computer system 60 includes at least one computer readable medium or memory programmed according to the teachings of the invention and for containing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, Flash Memory, etc. Stored on any one or on a combination of computer readable media, the present invention includes software for controlling the computer system 60, for driving a device or devices for implementing the invention, and for enabling the computer system 60 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 62 for execution. A computer readable medium may take many forms, including but not limited to, non-volatile media, volatile media, and transmission media. Non-volatile media includes, for example, optical, magnetic disks, and magneto-optical disks, such as storage device 65. Volatile media includes dynamic memory, such as main memory 63. Transmission media includes coaxial cables, copper wire, Ethernet, wireless Ethernet and fiber optics, including the wires that comprise bus 61. Transmission media also may also take the form of acoustic or light waves, such as those generated during radio wave and infrared data communications.

Common forms of computer readable media include, for example, hard disks, floppy disks, tape magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 62 for execution. For example, the instructions may initially be carried on a magnetic disk of a remote computer. The remote computer can load the instructions for implementing all or a portion of the present invention remotely into a dynamic memory and send the instructions over a telephone line through a modem, or Ethernet connection or wireless connection using a network interface card (NIC). Likewise, a modem or NIC local to computer system 60 may receive the data on the telephone line, Ethernet or wireless connection and use an infrared transmitter to convert the data to an infrared signal. An infrared detector couple to bus 61 can receive the data carried in the infrared signal and place the data on bus 61. The bus 61 carries the data to main memory 63, from which processor 62 receives and executes the instructions. The instructions received by main memory 63 may optionally be stored on storage device 65 either before or after execution by processor 62.

The computer system 60 also includes a communication interface 67 coupled to bus 61. Communication interface 67 provides a two-way data communication coupling to a network link 74 that may be connected to, for example, a local network 75. For example, communication interface 67 may be a network interface card to attach to any packet switched local area network (LAN). As another example, communication interface 67 may be an asymmetrical digital subscriber line (ADSL) card, an integrated services digital network (ISDN) card or a modem to provide a data communication connection to a corresponding type of telephone line. Ethernet and wireless links may also be implemented via the communication interface 67. In any such implementation, communication interface 67 sends and receives electrical, electromagnetic, RF or optical signals and carry digital data streams representing various types of information.

Network link 74 typically provides data communication through one or more networks to other data devices. For example, network link 74 may provide a connection to a computer 76 through local network 75 (e.g., a LAN) or through equipment operated by a service provider, which provides communication services through a communications network 77. Similarly, remote mobile communications 78 and interface is possible through equipment and systems operated by a service provider, such as a cellular network provider, which provides communication services through a communications network 79. In preferred embodiments, local network 75 and communications network 74 preferably use electrical, electromagnetic, RF or optical signals that carry digital data streams. The signals through the various networks and the signals on network link 74 and through communication interface 67, which carry the digital data to and from computer system 60, are exemplary forms of carrier waves transporting the information. The computer system 60 can transmit notifications and receive data, including program code, through the network(s), network link 74 and communication interface 67.

The Electronic Hydropod can be configured in a broad number of configurations for varying power generation and space considerations such as, varying the configurations and combinations of the variable parameters of rotor diameter; quantum, configuration and orientation of nozzles; quantum, configuration and orientation of fluid flow channels; axial height or length of the hydro-rotor assembly cylinder whether integral or comprised of modular segments; distance between nozzles and vanes; quantum, configuration and orientation of nozzles jet-streams to vane surfaces; quantum, configuration and orientation of thrust vanes; fluid flow management schemes and systems; and the space between vanes and container. Still further, the Electronic Hydropod can be adapted to provide a source of renewable power in a broad array of useful applications requiring a self-sustainable, environmentally friendly and economical source of power that can be derived from the output shaft of the Electronic Hydropod.

In such alternative applications, in lieu of monitoring the output of the electrical generator in a closed loop fashion to regulate the speed of the Electronic Hydropod, the speed of the Electronic Hydropod drive shaft can be monitored for instance by a tachometer. The tachometer is in turn coupled to and its output is interpreted by a control logic circuit of a voltage regulator system which then automatically applies the appropriate DC voltage to the DC magnetic system coils in order to maintain the hydro-rotor rotational speed within a specified application operating speed. In yet other applications, the system output of the alternative device being powered by the Electronic Hydropod drive shaft is monitored by an appropriate means for the specific application such as but not limited to, shaft speed, flow rate, pressure, etc., wherein such monitoring device output is in turn coupled to and interpreted by a control logic circuit of a voltage regulator system which then automatically applies the appropriate DC voltage to the DC magnetic system coils in order to maintain the hydro-rotor rotational speed within a specified application operating speed.

In still further embodiments, the commercially available AC electrical generator (or custom manufactured generator) mounted external to the hydropod and driven by the output shaft of the hydropod is replaced with an internally integrated electrical generator which is driven by a common shaft on the rotating axis of the DC magnetics system and/or hydro-rotor assembly. Also, the hydropod can be driven by an AC drive system in lieu of the DC magnetics drive system. In this configuration, the AC drive system electrical windings initialize the rotation of the hydro-rotor and fluid propulsion system. The AC drive system can comprise a plurality of poles with corresponding electrical coils, such that when an AC voltage is applied it produces a rotational force capable of developing sufficient torque to rotate the hydro-rotor assembly to a predetermined speed (RPM). The AC drive system also serves to regulate the electrical output of the system driven electrical generator by controlling and regulating the rotational speed of the hydro-rotor assembly.

As with the DC drive system alternate embodiment, the AC electrical generator can be driven by the hydro-rotor output shaft, or be internally integrated and driven by a common shaft on the rotating axis of the AC drive system and/or hydro-rotor assembly. Each the DC drive system configuration and the AC drive system configuration can also be used to power DC generators as well as a wide variety of other devices which can benefit from a source of renewable power in a broad array of useful applications requiring a self-sustainable, environmentally friendly and economical source of power that can be derived from the output shaft of the Electronic Hydropod. In still further embodiments, the hydropod and/or complete Electronic Hydropod can be adapted to operate with the rotational axis being positioned in any orientation including horizontal.

What is claimed as new and desired to be secured by Letters Patent of the United States is:

1. An electronic hydropod system for producing environmentally friendly renewable electrical power energy, comprising:
a) a hydro-rotor assembly comprising a fluid propulsion system and at least one hydro-rotor comprising at least one jet-stream nozzle;
b) a fixed volume of a closed-loop working fluid medium;
c) a containment housing with a plurality of vanes or other thrust producing surfaces, a fluid management infrastructure and a reservoir;
d) a DC magnetics system adapted to be coupled to the hydro-rotor assembly wherein the DC magnetics system initializes the rotation of the hydro-rotor assembly so as to act as a centrifugal pump system utilizing thermal energy, kinetic energy, fluid dynamics, mass inertia and centrifugal forces to sustain the rotation of the hydro-rotor assembly; and
e) a shaft mechanically coupled to the hydro-rotor assembly driving at least one electrical generator to produce electrical power.

2. The system in claim 1, in which the DC magnetics system comprises a plurality of poles with corresponding electrical coils, and fixed permanent or electronic magnets and corresponding coils, such that when a DC voltage is applied it produces a rotational force capable of developing sufficient torque to rotate the hydro-rotor assembly to a predetermined speed (RPM).

3. The system as claimed in claim 2, wherein the DC magnetics system comprises means for regulating the electrical output of the system driven electrical generator by controlling and regulating the rotational speed of the hydro-rotor assembly.

4. The system in claim 3, comprising a means for raising and lowering the quantum of DC voltage applied to the DC magnetics system coils in order to produce sufficient magnetic field strengths to initiate and maintain rotation of the hydro-rotor assembly at a predetermined operational speed.

5. The system in claim 4, comprising a means for varying the DC voltage to achieve manipulation of the DC magnetic field so as to slow down or speed up as required the rotational speed of the hydro-rotor assembly.

6. The system in claim 5, comprising a means for generating drag and reversing rotational torque sufficient to aid in bringing the hydro-rotor assembly to a halt.

7. The system in claim 4, wherein the output of the electrical generator is monitored by a voltage regulator circuit which then automatically applies the appropriate DC voltage to the DC magnetics system coils in order to maintain the hydro-rotor rotational speed within a specified generator operating speed such as but not limited to 1800 rpm.

8. The system in claim 2, comprising a DC power circuit comprising a DC power source such as a battery.

9. The system in claim 8, comprising any number of commercially available or specifically configured batteries designed for deep cycle operation, or plurality of such batteries.

10. The system in claim 8, comprising a DC charging system to replace the DC power which was furnished by the battery, thereby creating a closed loop self-sufficient DC system.

11. The system in claim 10, comprising a means for converting some of the electrical generator output to the appropriate DC voltage to charge the battery or other DC source.

12. The system in claim 11, comprising DC voltage output from a transformer/rectifier control circuit or similar system/device.

13. The system in claim 10, comprising a DC output from the DC magnetics system surplus power generated.

14. The system in claim 10, comprising a combination of DC output from the DC magnetics system surplus power and a generator output conversion system.

15. The system in claim 10, comprising a voltage regulator circuit or system to prevent over charging or cycling the DC source and/or battery once it has been brought back to full charge.

16. The system in claim 15, such system thereafter mitigating further unnecessary losses to the electronic hydropod system.

17. The system in claim 1, wherein such electrical generator is externally mounted and mechanically driven via a hydro-rotor assembly powered rotating shaft either through a direct coupling connection or via a drive train.

18. The system in claim 17, comprising either a commercially available electrical generator or a custom manufactured generator such as a synchronous AC generator.

19. The system in claim 1, wherein such electrical generator is comprised of an internally integrated electrical generator being driven by a common shaft on the rotating axis of the DC magnetics system and/or hydro-rotor assembly.

20. The system in claim 2, further comprising a means and system for the DC magnetics system to mechanically drive the rotation of the hydro-rotor assembly in order to initiate and sustain the fluid propulsion system.

21. The system in claim 20, comprising a DC magnetics system armature and a direct mechanical drive between the DC magnetics system armature and the hydro-rotor assembly.

22. The system in claim 21, in which such hydro-rotor assembly direct mechanical drive means or dive shaft is an integral part and function of a hydro-rotor assembly top support shaft.

23. The system in claim 21, in which the DC magnetics system armature direct drive means comprises any of a variety of commercially available couplings to mechanically link to a shaft connected or integral to the top of the hydro-rotor assembly.

24. The system in claim 2, comprising a system in which permanent or electronic magnets and corresponding coils are affixed to a container system or otherwise to hydropod device stationary infrastructure, and a DC magnetics system armature with DC coils affixed to rotate about the axis of the hydro-rotor assembly axis.

25. The system in claim 24, such that the DC armature and permanent or electronic magnets system comprises a large geometrical diameter which optimizes the thrust and torque generating capability upon the central shaft/drive mechanism when DC voltage is applied.

26. The system in claim 2, comprising a drive train mechanism whereby the torque of a DC magnetics system armature is transferred to the hydro-rotor assembly.

27. The system in claim 2, comprising a system in which magnets are affixed to the hydro-rotor assembly outer diameter and DC coils are affixed to a hydropod device container or otherwise to hydropod device stationary infrastructure to drive the hydro-rotor assembly to initiate and sustain the fluid propulsion system.

28. The system in claim 27, comprising a plurality of magnets spaced radially and/or axially in relation to the hydro-rotor assembly outer diameter.

29. The system in claim 27, comprising a plurality of coils spaced radially and/or axially in relation to the hydro-rotor assembly outer diameter.

30. The system in claim 2, comprising a means and system for the DC magnetics system to mechanically drive an electrical generator in order to produce electrical power with the hydropod system.

31. The system in claim 30, comprising a direct mechanical drive between a DC magnetics system armature and electrical generator whereby the torque of the DC magnetics system armature is transferred to the drive shaft of the electrical generator.

32. The system in claim 31, wherein such DC magnetics system armature drive shaft is an integral part and function of a hydro-rotor assembly top support shaft.

33. The system in claim 31, wherein such direct mechanical drive between the DC magnetics system armature and electrical generator being comprised of any one of a variety of commercially available couplings.

34. The system in claim 30, comprising a drive train mechanism whereby the torque of a DC magnetics system armature is transferred to the drive shaft of an electrical generator.

35. The system in claim 1, in which the hydro-rotor assembly comprises a cylindrical geometry further comprising a center cavity and a plurality of fluid flow channels extending from the center cavity radially outward to the outside edge of the hydro-rotor cylinder.

36. The system in claim 35, with such fluid flow channels being curved in shape to provide for efficient flow, minimize losses yet provide for an orifice and jet-stream exiting angle closer in relation to a plane tangent to the hydro-rotor outer diameter than can be achieved by straight channels to near tangency with the central cavity diameter.

37. The system in claim 36, in which the hydro-rotor is comprised of a hydro-rotor disk assembly comprising a hydro-rotor disk split in two halves perpendicular to the axis of rotation for ease of producing the fluid flow channel geometries.

38. The system in claim 37, such hydro-rotor disk assemblies comprising a single or plurality of sealing devices such as O-rings, seals or gaskets between the two halves to eliminate system losses to leakage.

39. The system in claim 38, such seals and/or gaskets being positioned radially or otherwise between the fluid flow channels to prevent leakage from one channel from adversely affecting the fluid flow in adjacent fluid flow channels.

40. The system in claim 35, with such fluid flow channels decreasing in diameter from inlet to outlet to increase the velocity of the fluid medium thereby increasing the velocity of the jet-stream at the orifice outlets.

41. The system in claim 40, with such fluid flow channels being curved in shape to provide for efficient flow, minimize losses and provide for an orifice and jet-stream exiting angle closer in relation to a plane tangent to the rotor outer diameter than can be achieved by straight channels from near tangency with the rotor central cavity diameter.

42. The system in claim 35, with such hydro-rotor comprising a plurality of individual axially stacked rotor disks or disk assemblies with corresponding center cavities and a plurality of fluid flow channels extending from the center cavity radially outward to the outside edge of the rotor outer diameter.

43. The system in claim 42, with such hydro-rotor assembly stack further comprising a rotational offset between the various individual disks or rotor segments such that the exiting jet-stream orifices stagger rotationally rather than line-up along a common vertical axis on the outside diameter of the hydro-rotor assembly stack, thereby minimizing the effective distance (or rotational angle) between the various orifice outputs in the rotor stack.

44. The system in claim 43, with such hydro-rotor disk assembly axial and rotational staggering of orifice outputs comprised in a single rotor cylinder with integral axial and radially staggered outputs.

45. The system in claim 35, in which the fluid flow channels comprise jet-stream forming devices at the outside diameter of the rotor/disk outer diameter serving as nozzles in order to optimize the velocity and force of the exiting jet-stream.

46. The system in claim 35, in which such hydro-rotor is comprised of metal alloys thus providing machinability and rotational inertia mass.

47. The system in claim 35, in which such hydro-rotor is configured to utilize inert matter, stone, cement, synthetics, etc. as cost effective mass for rotational inertia.

48. The system in claim 35, with such hydro-rotor configurations and combinations comprising any combination of the variable parameters of rotor diameter; quantum, configuration and orientation of nozzles; quantum, configuration and orientation of fluid flow channels; axial height or length of the hydro-rotor assembly cylinder whether integral or comprised of modular segments; distance between nozzles and container fixed vanes; quantum, configuration and orientation of nozzles jet-streams to vane surfaces; fluid flow management systems; and space between vanes and container structure.

49. The system in claim 1, comprising a rotational centering shaft system further comprising one or more shafts to maintain the rotational axis of the hydro-rotor assembly.

50. The system in claim 1, comprising a rotational centering shaft system further comprising one or more shafts to maintain the rotational axis of the hydro-rotor assembly and to support the weight of the hydro-rotor assembly.

51. The system in claim 1, comprising a bottom shaft and centering means to maintain the rotational axis of the hydro-rotor and to support the weight of the hydro-rotor.

52. The system in claim 51, comprising a low friction bushing, liner, material or surface treatment to support the hydro-rotor assembly and/or bottom shaft, providing low resistance to rotation and rotational centering.

53. The system in claim 52, comprising a plurality of low friction bushings, liners, materials and/or surface treatments to support the hydro-rotor assembly and/or bottom shaft.

54. The system in claim 52, comprising a system and means for circulating the working fluid media to the shaft/bushing/liner/material/surface treatment interfaces and systems for cooling and lubrication purposes.

55. The system in claim 54, such circulation system and means comprising directional fluid channels or other means to manage fluid flow.

56. The system in claim 54, such circulation system and means comprising an impeller, turbine, or otherwise dynamic flow producing device.

57. The system in claim 51, comprising a roller bearing, tapered roller bearing, beveled bearings, thrust bearing or other dynamic mechanical bearing configuration to support the hydro-rotor assembly and/or bottom shaft providing low resistance to rotation and rotational centering.

58. The system in claim 57, comprising a plurality of bearings or bearing combinations to support the hydro-rotor assembly and/or bottom shaft.

59. The system in claim 57, comprising a system and means for circulating the working fluid media to the shaft/bearing interfaces and systems for cooling and lubrication.

60. The system in claim 59, such circulation system and means comprising directional fluid channels or other means to manage fluid flow.

61. The system in claim 59, such circulation system and means comprising an impeller, turbine, or otherwise dynamic flow producing device.

62. The system in claim 51, comprising any one or combination of electric bearing, electronic bearing, magnetic bearing or other dynamic “no-contact, air ride” type bearing(s) configurations to support the rotor assembly and/or bottom shaft, providing low or no resistance to rotation and rotational centering.

63. The system in claim 51, comprising any combination of dynamic bearings and low friction static materials and surface treatments.

64. The system in claim 1, comprising a means and system for supporting the weight of the hydro-rotor assembly while also providing a means and system for providing low resistance rotational centering about the rotational axis of the hydro-rotor.

65. The system in claim 64, comprising a system of bearing(s), bushing(s), liner(s), materials and/or surface treatments to support the hydro-rotor assembly, provide low resistance to rotation and provide rotational centering.

66. The system in claim 65, comprising no central support or rotational “shaft”.

67. The system in claim 1, comprising a top shaft and bearing system to maintain the rotational axis of the hydro-rotor and to offer stability to the system during operation and transport.

68. The system in claim 67, comprising a roller bearing, tapered roller bearing, beveled bearings, thrust bearing or other mechanical dynamic bearing configuration.

69. The system in claim 68, comprising a plurality of bearings or bearing combinations.

70. The system in claim 67, such bearing system being comprised of low friction bushing, liner, material and/or surface treatment.

71. The system in claim 70, comprising a plurality of bushings, liners, materials and/or surface treatments.

72. The system in claim 67, comprising a combination of dynamic bearings and low friction static materials and surface treatments.

73. The system in claim 67, comprising a system and means for circulating the working fluid media to the bearing system for the purpose of cooling the bearing(s).

74. The system in claim 73, such circulation system and means comprising directional fluid channels or other means to manage fluid flow.

75. The system in claim 73, such circulation system and means comprising an impeller, turbine, or otherwise dynamic flow producing device.

76. The system in claim 67, comprising an electric bearing, electronic bearing, magnetic bearing or other dynamic “no-contact, air ride” type bearing(s) bearing configuration to support the hydro-rotor assembly and/or bottom shaft providing low or no resistance to rotation and rotational centering.

77. The system in claim 76, comprising a plurality of such bearing combinations.

78. The system in claim 76, comprising a system and means for circulating the working fluid media to the shaft/bearing interfaces and systems for cooling and lubrication.

79. The system in claim 78, such circulation system and means comprising directional fluid channels or other means to manage fluid flow.

80. The system in claim 78, such circulation system and means comprising an impeller, turbine, or otherwise dynamic flow producing device.

81. The system in claim 67, comprising any combination of dynamic bearings and low friction static materials and surface treatments.

82. The system in claim 1, comprising a single or plurality of spacers or shims to compensate for dimensional tolerances and ensure that bearings and/or bearing surfaces are properly located to distribute system loads to design specifications.

83. The system in claim 1, comprising a means and system for lifting, holding, installing and otherwise facilitating transport of the hydro-rotor assembly.

84. The system in claim 83, comprising a plurality of permanent or removable lifting support structures such as eyebolts in a hydro-rotor assembly top plate.

85. The system in claim 83, comprising a mechanical feature on a hydro-rotor assembly top shaft such as an I.D. or O.D. thread.

86. The system in claim 1, comprising a means and system for the hydro-rotor assembly to mechanically drive an electrical generator in order for the system to produce electrical power.

87. The system in claim 86, comprising a hydro-rotor assembly drive shaft with mechanical features to facilitate coupling to the generator drive shaft or otherwise mechanically driving the rotation of the generator.

88. The system in claim 87, such hydro-rotor assembly drive shaft being an integral part and function of the hydro-rotor assembly top bearing support shaft.

89. The system in claim 86, such hydro-rotor assembly drive shaft driving the electrical generator shaft indirectly through gearing, pulleys, belts, etc.

90. The system in claim 86, such hydro-rotor assembly drive shaft being common with the DC magnetics system armature.

91. The system in claim 86, such generator drive being located at the opposite axial end of the hydro-rotor assembly from the DC magnetics system.

92. The system in claim 1, comprising a structural container which houses and supports the hydro rotor assembly, thrust vanes and support infrastructure, internal mechanical support infrastructure and serving to contain and manage the fluid media.

93. The system in claim 92, comprising a means and system for supporting the vanes around the circumference of, and in close proximity to, the rotating hydro-rotor assembly and transferring the hydro-rotor assembly nozzle jet-stream force upon the vanes and in turn to the stationary structural case, thus causing the hydro-rotor assembly to spin or rotate about its axis.

94. The system in claim 93, such vane being positioned and shaped to efficiently process the fluid emitted from the rotating hydro-rotor assembly nozzles and direct it away from the multiple system jet-streams so as to minimize turbulence, minimize oxygen entrapment in the fluid, avoid interference with or impinge other jet-streams, and to recycle fluid back to the propulsion system fluid reservoir.

95. The system in claim 93, such vanes being positioned and shaped to efficiently allow the jet-streams being emitted from the hydro-rotor assembly nozzles to generate a rotational thrust force tangent to the outer diameter of the hydro-rotor assembly.

96. The system in claim 95, such vanes being concave in geometry relative to the direction of the jet-stream.

97. The system in claim 95, such vanes being convex in geometry relative to the direction of the jet-stream.

98. The system in claim 95, such vanes being flat in geometry and positioned at predetermined angles relative to the direction of the jet-stream.

99. The system in claim 95, such vane position and orientation relative to the rotating hydro-rotor assembly nozzles being adjustable for optimum hydro performance.

100. The system in claim 99, comprising a system and method for remotely adjusting the vane position and orientation relative to the rotating hydro-rotor assembly nozzle jet-streams vector for optimum thrust generation and dynamic hydro performance at various hydro-rotor assembly rotational speeds.

101. The system in claim 100, such vane position and orientation adjustment system being mechanically similar to any conventional pivoting louvered systems.

102. The system in claim 100, such vane position and orientation adjustment system being electro-mechanical and/or servo-controlled similar to a jet/turbine engine exhaust thrust vector control system.

103. The system in claim 93, such vanes being mounted and positioned approximately parallel to the axis of the hydro-rotor assembly.

104. The system in claim 93, such vanes being mounted and positioned at a skewed angle relative to the axis of the hydro-rotor assembly thereby facilitating “lift” forces from the nozzle jet-streams to reduce lower shaft and/or bearing friction and system drag.

105. The system in claim 93, such vanes being supported by a plurality of support rings or similar structure which transfer the force from the hydro-rotor assembly nozzle jet-streams to the stationary structural case.

106. The system in claim 105, such support rings configured with channels and fluid passages to facilitate the efficient processing of the fluid after contact with the vanes and to efficiently promote gravitational return of the fluid to the propulsion system reservoir.

107. The system in claim 105, such vane support infrastructure having slotted geometry which closely matches and encapsulates the cross-section of the vanes to facilitate transferring jet-steam loads to the infrastructure.

108. The system in claim 105, such vane support infrastructure comprising a removable locking device such as a bolt or setscrew to facilitate installation, adjustment and replacement of the vanes.

109. The system in claim 92, comprising a means and system for supporting the hydro-rotor assembly and centering its axis of rotation relative to the vanes, vanes support infrastructure and structural container.

110. The system in claim 109, comprising a means and system for aligning and positioning the hydro-rotor assembly nozzles relative to vanes for optimum hydro performance.

111. The system in claim 109, comprising a means and system for transferring the static and dynamic loads of the rotor-assembly to the structural case.

112. The system in claim 92, comprising a means and system for managing the flow of fluid after contact with the vanes and re-circulating the fluid efficiently back to the fluid propulsion system reservoir.

113. The system in claim 112, comprising a plurality of spaced gussets/diffusers located radially against the structural container outer wall, and below the plane of the bottom of the hydro-rotor assembly.

114. The system in claim 113, such gussets/diffusers functioning to impede a rotational swirling of the fluid and direct it back to the fluid propulsion system reservoir, as well as provide structural integrity to the container.

115. The system in claim 113, such gussets/diffusers being axially aligned with gussets/diffusers positioned adjacent to the vanes and/or above the top plane of the hydro-rotor assembly to function as a complimentary laminar flow system and promote efficient fluid flow back to the propulsion system reservoir.

116. The system in claim 113, such gussets/diffusers being mounted and positioned approximately parallel to the axis of the hydro-rotor assembly.

117. The system in claim 113, such gussets/diffusers being mounted and positioned at a skewed angle relative to the axis of the hydro-rotor assembly or incorporating a curved plane geometry.

118. The system in claim 113, such gussets/diffusers being so located and comprising such geometry so as to efficiently direct the returning fluid flow to the fluid propulsion system reservoir in a flow path directly toward the center of the container for efficient propulsion system pick-up and circulation.

119. The system in claim 113, such gussets/diffusers radial positioning further serving to bisect the bearing resonating frequency(s) and thus enabling effective distribution to and absorption by the structural container/case.

120. The system in claim 112, comprising a plurality of spaced gussets/diffusers located radially between the vanes and the structural container outer wall, and approximately adjacent to the vanes.

121. The system in claim 120, such gussets/diffusers functioning to impede a rotational swirling of the fluid and direct it back to the fluid propulsion system reservoir, as well as provide structural integrity to the container.

122. The system in claim 120, such gussets/diffusers being axially aligned with gussets/diffusers positioned above the top plane and/or below the bottom plane of the hydro-rotor assembly to function as a complimentary laminar flow system and promote efficient fluid flow back to the propulsion system reservoir.

123. The system in claim 120, such gussets/diffusers being mounted and positioned approximately parallel to the axis of the hydro-rotor assembly.

124. The system in claim 120, such gussets/diffusers being mounted and positioned at a skewed angle relative to the axis of the hydro-rotor assembly or incorporating a curved plane geometry.

125. The system in claim 120, such gussets/diffusers radial positioning further serving to bisect the bearing resonating frequency(s) and thus enabling effective distribution to and absorption by the structural container/case.

126. The system in claim 112, comprising a plurality of spaced gussets/diffusers located between the structural container hydro/wet section top plate and the outer wall, and located above the plane of the top of the centrifugal pump/hydro-rotor assembly.

127. The system in claim 126, such gussets/diffusers functioning to impede a rotational swirling of the fluid and direct it back to the fluid propulsion system reservoir, as well as provide structural integrity to the container.

128. The system in claim 126, such gussets/diffusers being axially aligned with the gussets/diffusers positioned adjacent to the vanes and/or below the bottom plane of the hydro-rotor assembly to function as a complimentary laminar flow system and promote efficient fluid flow back to the propulsion system reservoir.

129. The system in claim 126, such gussets/diffusers being mounted and positioned parallel to the axis of the hydro-rotor assembly.

130. The system in claim 126, such gussets/diffusers being mounted and positioned at a skewed angle relative to the axis of the hydro-rotor assembly or incorporating a curved plane geometry.

131. The system in claim 126, such gussets/diffusers radial positioning further serving to bisect the bearing resonating frequency(s) and thus enabling effective distribution to and absorption by the structural container/case.

132. The system in claim 92, comprising modular assembly provisions whereby the structural case is manufactured in stages and further providing the container with structural integrity.

133. The system in claim 132, comprising a section or stage with the vanes and related support infrastructure.

134. The system in claim 133, comprising fluid management passages, gussets/diffusers.

135. The system in claim 132, comprising a section or stage with a container base and hydro-rotor lower shaft/bearing support infrastructure.

136. The system in claim 135, comprising fluid management channels and gussets/diffusers.

137. The system in claim 135, comprising fluid sight-glass for monitoring fluid levels and flow.

138. The system in claim 135, comprising means to drain fluid, such as including a removable plug or drain valve.

139. The system in claim 135, comprising means to safely lift and maneuver the hydropod via forklift or similar lifting device(s).

140. The system in claim 132, comprising a section or stage with a hydro-rotor top shaft/bearing support infrastructure.

141. The system in claim 140, comprising fluid management gussets/diffusers.

142. The system in claim 140, comprising a top hydro-rotor shaft seal to prevent fluid from leaving the container.

143. The system in claim 140, comprising one or a plurality of breather devices which allow air to enter the container to facilitate efficient gravity return of the fluid to the propulsion system reservoir yet do not allow fluid to exit the container.

144. The system in claim 132, comprising a means and system of affixing and securing the sections/stages to one another.

145. The system in claim 132, comprising a means and system of securing sections/stages to one another and providing leak proof joints.

146. The system in claim 132, comprising a means and system of orientation, centering and rotational clocking of the various sections/stages to one another.

147. The system in claim 92, comprising a means and system for lifting the completely assembled electronic hydropod.

148. The system in claim 147, comprising a means and system for transferring the weight load of the complete system, or a portion thereof, to the bottom structural base plate via a plurality of rods spanning the overall container height, or point of lifting, and secured to the base plate.

149. The system in claim 147, comprising a means and system for distributing the system weight load over a plurality of lifting brackets positioned about the outer diameter of the case/container.

150. The system in claim 149, such lifting brackets being secured about the perimeter of the case to integral structural rings welded or otherwise secured to the case/container wall(s).

151. The system in claim 92, such outer case/container and/or infrastructure components being comprised of either metal materials or synthetic materials.

152. The system in claim 1, such propulsion system comprising a propulsion device such as a screw pump, impeller, propeller or other conventional fluid/medium “processing device”.

153. The system in claim 152, such propulsion system further comprising a cylindrical container device or similar structure which encapsulates and is oriented co-axially with the propulsion device, serving to prevent fluid cavitation, produce directional laminar flow coincident with the axis of the propulsion device, and facilitating the ability to generate fluid media pressure in the hydro-rotor assembly center cavity.

154. The system in claim 153, such cylindrical container device being of sufficient axial length to ensure that the propulsion device vacuum/suction/fluid inlet end of the cylindrical container is always below the level of the fluid in the reservoir during all operational modes to ensure fluid pick-up by the propulsion device.

155. The system in claim 153, such cylindrical container device further comprising an inside diameter which is equal to or only slightly larger than the effective outside diameter of the propulsion device to improve the efficiency of the integrated propulsion pump system as a flow and pressure source to the hydro-rotor assembly center cavity.

156. The system in claim 153, such cylindrical container device further comprising physical geometry in the form of concave scoops, blades, vanes or other common geometry intended to direct fluid in the reservoir into the cylindrical device inlets to improve the efficiency of the propulsion device and integrated propulsion system as a flow and pressure source to the hydro-rotor assembly center cavity.

157. The system in claim 156, such concave scoops, blades, vanes or other common geometry and corresponding holes/channels/opening being configured and aligned so as to efficiently feed fluid between the individual working blades of the propulsion device.

158. The system in claim 153, such cylindrical container device and propulsion device being mechanically affixed to one another so as to rotate as a single unit.

159. The system in claim 158, further comprising a single integrated component which incorporates all of the cylindrical container device and propulsion device features and functions.

160. The system in claim 159, such integrated device being comprised of a commercially available, modified commercially available or specially designed pump such as but not limited to a centrifugal pump or pressure compensated centrifugal pump being integrated such that the fluid flow output of the pump flows to and pressurizes the center cavity of the hydro-rotor assembly.

161. The system in claim 160, such pump being integrated such that the rotation of the hydro-rotor assembly mechanically drives the input shaft or otherwise drives the internal components of the pump.

162. The system in claim 153, such pump system propulsion device and cylindrical container device features and functions being integrated with the hydro-rotor assembly bottom support shaft as an integrated system.

163. The system in claim 162, such propulsion device, cylindrical container device and hydro-rotor assembly bottom support shaft being mechanically affixed to one another so as to rotate as a single unit.

164. The system in claim 162, such cylindrical container device and hydro-rotor assembly bottom shaft being comprised of a single integrated component.

165. The system in claim 164, such integrated cylindrical container/hydro-rotor assembly bottom shaft device further comprising physical geometry in the form of concave scoops, blades, vanes or other common geometry intended to direct fluid in the reservoir into holes/channels/opening in the integrated device to improve the efficiency of the propulsion device and integrated propulsion pump system as a flow and pressure source to the hydro-rotor assembly center cavity.

166. The system in claim 165, such concave scoops, blades, vanes or other common geometry and corresponding holes/channels/opening being configured and aligned so as to efficiently feed fluid between the individual working blades of the propulsion device.

167. The system in claim 152, such propulsion system being co-axial to, and mechanically coupled to the hydro-rotor assembly thereby rotating as a single unit.

168. The system in claim 167, with such mechanical coupling further comprising a leak proof seal to improve the efficiency of the integrated propulsion system as a flow and pressure source to the hydro-rotor assembly center cavity.

169. The system in claim 152, such propulsion device functioning independent of and without being mechanically integrated with the bottom hydro-rotor assembly load bearing and rotational support system and means.

170. The system in claim 1, wherein the DC magnetics system comprises a replacement AC drive system comprising an AC electrical winding system and means for initializing the rotation of the hydro-rotor and pump system so as to act as a centrifugal pump system utilizing thermal energy, kinetic energy, fluid dynamics and mass inertia to sustain the rotation of the hydro-rotor assembly.

171. The system in claim 170, in which the AC drive system comprises a plurality of poles with corresponding electrical coils, such that when a AC voltage is applied it produces a rotational force capable of developing sufficient torque to rotate the hydro-rotor assembly to a predetermined speed (RPM).

172. The system as claimed in claim 171, wherein the AC drive system also serves to regulate the electrical output of the system driven electrical generator by controlling and regulating the rotational speed of the hydro-rotor assembly.

173. The system in claim 172, comprising a means of raising and lowering the quantum of AC voltage applied to the AC drive system coils in order to produce sufficient magnetic field strengths to initiate and maintain rotation of the hydro-rotor assembly at the predetermined operational speed.

174. The system in claim 173, comprising a means of varying the AC voltage to achieve manipulation of the AC magnetic field so as to slow down or speed up as required the rotational speed of the hydro-rotor assembly.

175. The system in claim 174, comprising a means to generate drag and reversing rotational torque sufficient to aid in bringing the hydro-rotor assembly to a halt.

176. The system in claim 173, wherein the output of the electrical generator is monitored by a voltage regulator circuit which then automatically applies the appropriate AC voltage to the AC drive system coils in order to maintain the hydro-rotor rotational speed within a specified generator operating speed such as but not limited to 1800 rpm.

177. The system in claim 171, comprising an AC power circuit comprising an AC power source.

178. The system in claim 170, wherein such electrical generator is comprised of an internally integrated electrical generator being driven by a common shaft on the rotating axis of the AC drive system and/or hydro-rotor assembly.

179. The system in claim 171, further comprising a means and system for the AC drive system to mechanically drive the rotation of the hydro-rotor assembly in order to initiate and sustain the fluid pumping system.

180. The system in claim 179, comprising a direct mechanical drive between an AC drive system armature and the hydro-rotor assembly.

181. The system in claim 180, in which such rotor assembly direct mechanical drive means or dive shaft is an integral part and function of the hydro-rotor assembly top support shaft.

182. The system in claim 180, in which the AC drive system armature direct drive means comprises any of a variety of commercially available couplings to mechanically link to a shaft connected or integral to the top of the hydro-rotor assembly.

183. The system in claim 171, comprising a drive train mechanism whereby the torque of an AC drive system armature is transferred to the hydro-rotor assembly.

184. The system in claim 171, comprising a means and system for the AC drive system to mechanically drive an electrical generator in order to produce electrical power with the hydropod system.

185. The system in claim 184, comprising a direct mechanical drive between the AC drive system armature and electrical generator whereby the torque of the AC drive system armature is transferred to the drive shaft of the electrical generator.

186. The system in claim 184, wherein such AC drive system armature drive shaft is an integral part and function of the rotor assembly top support shaft.

187. The system in claim 184, wherein such direct mechanical drive between the AC drive system armature and electrical generator being comprised of any one of a variety of commercially available couplings.

188. The system in claim 184, comprising a drive train mechanism whereby the torque of the AC drive system armature is transferred to the drive shaft of an electrical generator.

189. The system in claim 170, such system embodiment being capable of, but not limited to, utilizing a traditional AC electrical power grid or other available AC primary source as a means of initiating and maintaining the rotation of the hydro-rotor assembly and thus providing cost effective supplemental AC power, thereby lowering the load and demand upon the primary AC source.

190. The system in claim 1, comprising a self-contained system capable of producing electrical power without external interface or control.

191. The system in claim 190, comprising a manual command or interface via system activation with a switch, ignition key or similar device, or via any means whereby DC Voltage is applied to the DC magnetics system.

192. The system in claim 170, comprising a self-contained system capable of producing electrical power without external interface or control.

193. The system in claim 192, comprising a manual command or interface via system activation with a switch, ignition key or similar device, or via any means whereby AC Voltage is applied to the AC drive system.

194. The system in claim 190, comprising an automatic system initiation from a standby mode via an electrical relay circuit to facilitate automatic and/or remote turn-on/off or to serve as “auto-start” auxiliary power when a main AC feed voltage is lost or interrupted, whereafter, DC Voltage is applied to the DC magnetics system.

195. The system in claim 192, comprising an automatic system initiation from a standby mode via an electrical relay circuit to facilitate automatic and/or remote turn-on/off or to serve as “auto-start” auxiliary power when a main AC feed voltage is lost or interrupted, whereafter, AC voltage is applied to the AC drive system.

196. The system in claim 1, comprising local or remote system monitoring of key variables, conditions and outputs.

197. The system in claim 196, comprising a broad range of system diagnostic devices integrated into the electronic hydropod system for information gathering and reporting coupled to or otherwise integrated with a monitoring and diagnostic interface containing such devices as, but not limited to, digital data display, CRT monitor, LCD or other display, and various analog and digital devices, meters, gages, readouts, etc.

198. The system in claim 197, comprising the systems and capabilities of monitoring system parameters including but are not limited to, DC voltage in/out, DC current in/out, generator AC voltage out, generator AC current out, RPM, ambient air temperature, reservoir fluid temperature, localized fluid temperatures, barometric pressure, bearing temperatures, fluid pressures/vacuums, vibration, strain gages, etc.

199. The system in claim 197, comprising the ability to monitor and trend key system parameters to facilitate predictive system required maintenance prior to unplanned interruption of service of the device.

200. The system in claim 1, comprising a means for local or remote system monitoring of key variables, conditions and outputs.

201. The system in claim 200, comprising a broad range of system diagnostic devices integrated into the electronic hydropod system for information gathering and reporting coupled to or otherwise integrated with a monitoring and diagnostic interface containing such devices as, but not limited to, digital data display, CRT monitor, LCD or other display, and various analog and digital devices, meters, gages, readouts, etc.

202. The system in claim 201, comprising the systems and capabilities of monitoring system parameters including but are not limited to, AC drive voltage in/out, AC drive current in/out, generator AC voltage out, generator AC current out, RPM, ambient air temperature, reservoir fluid temperature, localized fluid temperatures, barometric pressure, bearing temperatures, fluid pressures/vacuums, vibration, strain gages, etc.

203. The system in claim 201, comprising the ability to monitor and trend key system parameters to facilitate predictive system required maintenance prior to unplanned interruption of service of the device.

204. The system in claim 1, further comprising hard-wired or solid state circuitry for any function such as system start, system control, system monitoring and system diagnostics in place of or in conjunction with programmable or software controlled interfaces. Thus, embodiments are not limited to any specific combination of hardware circuitry and software.

205. The system in claim 1, wherein the speed of the electronic hydropod drive shaft is monitored by a tachometer which in turn is coupled to and its output is interpreted by a control logic circuit of a voltage regulator system which then automatically applies the appropriate DC voltage to the DC magnetics system in order to maintain the hydro-rotor rotational speed within a specified application operating speed.

206. The system in claim 1, wherein the electrical generator for producing renewable electrical power is replaced with any number of devices in furtherance of a multitude of applications requiring a self-sustainable, environmentally friendly and economical source of power that can be derived by the output shaft of the electronic hydropod.

207. The system in claim 206, wherein the speed of the electronic hydropod drive shaft is monitored by a tachometer which in turn is coupled to and its output is interpreted by a control logic circuit of a voltage regulator system which then automatically applies the appropriate DC voltage to the DC magnetics system in order to maintain the hydro-rotor rotational speed within a specified application operating speed.

208. The system in claim 206, wherein the output of the alternative device being powered by the electronic hydropod drive shaft is monitored by an appropriate means for the specific application such as but not limited to, shaft speed, flow rate, pressure, etc., wherein such monitoring device output is in turn coupled to and interpreted by a control logic circuit of a voltage regulator system which then automatically applies the appropriate DC voltage to the DC magnetics system in order to maintain the hydro-rotor rotational speed within a specified application operating speed.

209. The system in claim 1, wherein like systems are combined or networked together in series or parallel to produce electrical power in the aggregate.

210. The system in claim 190, comprising an automatic system initiation from a standby mode via an electrical relay circuit to facilitate automatic and/or remote turn-on/off or to serve as “auto-start” auxiliary power when a predetermined condition exists or an event occurs such as but not limited to a time of day, light level or temperature level, whereafter, DC Voltage is applied to the DC magnetics drive system.

211. The system in claim 192, comprising an automatic system initiation from a standby mode via an electrical relay circuit to facilitate automatic and/or remote turn-on/off or to serve as “auto-start” auxiliary power when a predetermined condition exists or an event occurs such as but not limited to a time of day, light level or temperature level, whereafter, AC voltage is applied to the AC drive system.

212. A method for producing environmentally friendly renewable electrical power energy, comprising:
a) coupling a DC magnetics system to a hydro-rotor comprising at least one jet-stream nozzle;
b) coupling a fluid propulsion system to a center cavity of the hydro-rotor forming a hydro-rotor assembly;
c) providing a containment housing with a plurality of thrust producing vanes or other thrust surfaces, a fluid management infrastructure and a reservoir,
d) providing a means for re-using a fixed volume of a fluid medium;
e) providing a means for supplying the DC magnetics system with DC voltage to initialize the rotation of the hydro-rotor and fluid propulsion system so as to act as a centrifugal pump system utilizing thermal energy, kinetic energy, fluid dynamics, mass inertia and centrifugal forces to sustain the rotation of the hydro-rotor assembly; and
f) coupling at least one electrical generator drive shaft to the hydro-rotor to produce electrical power.

213. The method in claim 212, further comprising:
a) providing a DC magnetics system comprising a plurality of poles with corresponding electrical coils and fixed permanent or electronic magnets and corresponding coils; and
b) applying DC voltage to produce a rotational force capable of developing sufficient torque to rotate the hydro-rotor assembly to a predetermined speed (RPM).

214. The method in claimed in claim 213, further comprising:
regulating the electrical output of the electrical generator by controlling and regulating the rotational speed of the hydro-rotor assembly.

215. The method in claim 214, further comprising:
raising and lowering the quantum of DC voltage applied to the DC magnetics system coils in order to produce sufficient magnetic field strengths to initiate and maintain rotation of the hydro-rotor assembly at the predetermined operational speed.

216. The method in claim 215, further comprising varying the DC voltage to achieve manipulation of the DC magnetic field so as to slow down or speed up as required the rotational speed of the hydro-rotor assembly.

217. The method in claim 216, further comprising generating a drag by reversing rotational torque sufficient to aid in bringing the hydro-rotor assembly to a halt.

218. The method in claim 216, further comprising coupling a voltage regulator circuit to the output of the electrical generator to monitor the output voltage and then automatically apply the appropriate DC voltage to the DC magnetic system coils in order to maintain the hydro-rotor rotational speed within a specified generator operating speed such as but not limited to 1800 rpm.

219. The method in claim 213, further comprising coupling a DC power circuit to the DC magnetics system comprising a DC power source such as a battery.

220. The method in claim 219, further comprising coupling any number of commercially available or specifically configured batteries designed for deep cycle operation, or plurality of such batteries.

221. The method in claim 219, further comprising coupling a DC charging system to replace the DC power which was furnished by the battery, thereby creating a closed loop self-sufficient DC system.

222. The method in claim 221, further comprising coupling a transformer/rectifier control circuit or similar system/device to the output of the electrical generator and converting some of the electrical generator output to the appropriate DC voltage to charge the battery or other DC source.

223. The method in claim 221, further comprising re-charging the DC source with DC magnetics system surplus DC power.

224. The method in claim 221, further comprising combining the DC magnetics system surplus power and a generator output conversion system to re-charge the DC source.

225. The method in claim 221, further comprising coupling a voltage regulator circuit to the DC power circuit to prevent over charging or cycling the DC source and/or battery once it has been brought back to full charge.

226. The method in claim 212, further comprising coupling such electrical generator to be mechanically driven via a hydro-rotor assembly powered rotating shaft either through direct coupling connection or via a drive train.

227. The method in claim 212, further comprising coupling an internally integrated electrical generator driven by a common shaft on the rotating axis of the DC magnetics system and/or hydro-rotor assembly.

228. The method in claim 213, further comprising coupling a DC magnetics system armature to the hydro-rotor assembly to mechanically drive the rotation of the hydro-rotor assembly in order to initiate and sustain the fluid pumping system.

229. The method in claim 228, further comprising providing a coupling that is an integral part and function of a hydro-rotor assembly top support shaft to directly drive the hydro-rotor assembly.

230. The method in claim 228, further comprising providing any of a variety of commercially available couplings to enable the DC magnetics system armature to mechanically drive a shaft connected or integral to the top of the hydro-rotor assembly.

231. The method in claim 213, further comprising coupling the permanent or electronic magnets and corresponding coils to the container system or otherwise to the hydropod device stationary infrastructure, and further comprising the DC armature with DC coils coupled to rotate about the axis of the hydro-rotor assembly axis.

232. The method in claim 231, further comprising providing a large geometrical diameter for the DC armature and permanent or electronic magnets system to optimize the thrust and torque generating capability upon the central shaft/drive mechanism when DC voltage is applied.

233. The method in claim 213, further comprising:
a) coupling magnets to the pump/hydro-rotor device outer diameter;
b) coupling DC coils to the hydropod device container or otherwise to hydropod device stationary infrastructure; and
c) applying DC voltage to create magnetic fields which drive the hydro-rotor assembly to initiate and sustain the fluid pumping system.

234. The method in claim 233, further comprising providing and coupling a plurality of magnets spaced radially and/or axially in relation to the hydro-rotor assembly outer diameter.

235. The method in claim 233, further comprising providing and coupling a plurality of coils spaced radially and/or axially in relation to the hydro-rotor assembly outer diameter.

236. The method in claim 213, further comprising coupling the DC magnetics system to an electrical generator.

237. The method in claim 236, further comprising a DC magnetics system armature transferring torque to the drive shaft of the electrical generator.

238. The method in claim 237, further comprising providing such DC magnetics system armature drive shaft as an integral part and function of the rotor assembly top support shaft.

239. The method in claim 237, further comprising providing any one of a variety of commercially available couplings.

240. The method in claim 212, further comprising providing the hydro-rotor assembly with a cylindrical geometry further comprising a center cavity and a plurality of fluid flow channels extending from the center cavity radially outward to the outside edge of the rotor cylinder.

241. The method in claim 240, further comprising providing such fluid flow channels curved in shape to provide for efficient flow, minimize losses yet provide for an orifice and jet-stream exiting angle closer in relation to a plane tangent to the rotor outer diameter than can be achieved by straight channels to near tangency with the rotor central cavity diameter.

242. The method in claim 241, further comprising providing the hydro-rotor in one or more individual hydro-rotor disk assemblies comprised of two halves split perpendicular to the axis of rotation for ease of producing the fluid flow channel geometries.

243. The method in claim 241, further comprising providing such hydro rotor disk assemblies with a single or plurality of sealing devices such as O-rings, seals or gaskets between the two halves to eliminate system losses to leakage.

244. The method in claim 2430, further comprising, providing such seals and/or gaskets positioned radially or otherwise between the fluid flow channels to prevent leakage from one channel from adversely affecting the fluid flow in adjacent fluid flow channels.

245. The method in claim 237, further comprising providing such fluid flow channels decreasing in diameter from inlet to outlet to increase the velocity of the fluid/medium thereby increasing the velocity of the jet-stream at the orifice outlets.

246. The method in claim 2452, further comprising providing such fluid flow channels curved in shape to provide for efficient flow, minimize losses and provide for an orifice and jet-stream exiting angle closer in relation to a plane tangent to the rotor outer diameter than can be achieved by straight channels from near tangency with the rotor central cavity diameter.

247. The method in claim 240, further comprising providing such hydro-rotor comprising a plurality of individual axially stacked rotor disks or disk assemblies with corresponding center cavities and a plurality of fluid flow channels extending from the center cavity radially outward to the outside edge of the rotor outer diameter.

248. The method in claim 247, further comprising providing such hydro-rotor assembly stack further comprising a rotational offset between the various individual disks or rotor segments such that the exiting jet-stream orifices stagger rotationally rather than line-up along a common vertical axis on the outside diameter of the hydro-rotor assembly stack, thereby minimizing the effective distance (or rotational angle) between the various orifice outputs in the rotor stack.

249. The method in claim 248, further comprising providing such hydro-rotor disk assembly axial and rotational staggering of orifice outputs comprised in a single rotor cylinder with integral axial and radially staggered outputs.

250. The method in claim 240, further comprising providing the fluid flow channels with jet-stream forming devices at the outside diameter of the rotor/disk outer diameter serving as nozzles in order to optimize the velocity and force of the exiting jet-stream.

251. The method in claim 240, further comprising providing such hydro-rotor manufactured from metal alloys thus providing machinability and rotational inertia mass.

252. The method in claim 240, further comprising providing such hydro-rotor configured to utilize inert matter, stone, cement, synthetics, etc. as cost effective mass for rotational inertia.

253. The method in claim 240, further comprising providing such hydro-rotor configurations comprising any combination of the variable parameters of rotor diameter; quantum, configuration and orientation of nozzles; quantum, configuration and orientation of fluid flow channels; axial height or length of the hydro-rotor assembly cylinder whether integral or comprised of modular segments; distance between nozzles and container fixed vanes; quantum, configuration and orientation of nozzles jet-streams to vane surfaces; fluid flow management systems; and space between vanes and container structure.

254. The method in claim 212, further comprising providing a rotational centering shaft system further comprising one or more shafts to maintain the rotational axis of the hydro-rotor system.

255. The method in claim 212, further comprising providing a rotational centering shaft system further comprising one or more shafts to maintain the rotational axis of the hydro-rotor assembly and supporting the weight of the hydro-rotor assembly.

256. The method in claim 212, further comprising providing a bottom shaft and centering means to maintain the rotational axis of the hydro-rotor and supporting the weight of the hydro-rotor.

257. The method in claim 256, further comprising providing a low friction bushing, liner, material or surface treatment to support the hydro-rotor assembly and/or bottom shaft, and providing low resistance to rotation and rotational centering.

258. The method in claim 257, further comprising providing a plurality of low friction bushings, liners, materials and/or surface treatments to support the hydro-rotor assembly and/or bottom shaft.

259. The method in claim 257, further comprising providing a system and means for circulating the working fluid media to the shaft/bushing/liner/material/surface treatment interfaces and systems for cooling and lubrication purposes.

260. The method in claim 259, further comprising providing such circulation system and means with comprising directional fluid channels or other means to manage fluid flow.

261. The method in claim 259, further comprising providing such circulation system and means with an impeller, turbine, or otherwise dynamic flow producing device.

262. The method in claim 256, further comprising providing a roller bearing, tapered roller bearing, beveled bearings, thrust bearing or other dynamic mechanical bearing configuration to support the hydro-rotor assembly and/or bottom shaft providing low resistance to rotation and rotational centering.

263. The method in claim 262, further comprising providing a plurality of bearings or bearing combinations to support the hydro-rotor assembly.

264. The method in claim 262, further comprising providing a system and means for circulating the working fluid media to the shaft/bearing interfaces and systems for cooling and lubrication.

265. The method in claim 264, further comprising providing such circulation system and means comprising directional fluid channels or other means to manage fluid flow.

266. The method in claim 264, further comprising providing such circulation system and means comprising an impeller, turbine, or otherwise dynamic flow producing device.

267. The method in claim 256, further comprising providing any one or combination of electric bearing, electronic bearing, magnetic bearing or other dynamic “no-contact, air ride” type bearing(s) configurations to support the rotor assembly and/or bottom shaft, providing low or no resistance to rotation and rotational centering.

268. The method in claim 256, further comprising providing any combination of dynamic bearings and low friction static materials and surface treatments.

269. The method in claim 212, further comprising providing a means and system of supporting the weight of the rotor assembly while also providing a means and system of providing low resistance rotational centering about the rotational axis of the rotor without the use of a bottom shaft.

270. The method in claim 212, further comprising providing a single or plurality of spacers or shims to compensate for dimensional tolerances and ensure that bearings and/or bearing surfaces are properly located to distribute system loads to design specifications.

271. The method in claim 212, further comprising providing a means and system for lifting, holding, installing and otherwise facilitating transport of the hydro-rotor assembly.

272. The method in claim 271, further comprising providing a plurality of permanent or removable lifting support structures such as eyebolts in the hydro-rotor assembly top plate.

273. The method in claim 271, further comprising providing a mechanical feature on the hydro-rotor assembly top shaft such as an I.D. or O.D. thread.

274. The method in claim 212, further comprising providing a means and system for the hydro-rotor assembly to mechanically drive an electrical generator in order for the system to produce electrical power.

275. The method in claim 274, further comprising providing a hydro-rotor assembly drive shaft with mechanical features to facilitate coupling to the generator drive shaft or otherwise mechanically driving the rotation of the generator.

276. The method in claim 275, further comprising providing such hydro-rotor assembly drive shaft as an integral part and function of the hydro-rotor assembly top bearing support shaft.

277. The method in claim 274, further comprising the hydro-rotor assembly drive shaft driving the electrical generator shaft indirectly through gearing, pulleys, belts, etc.

278. The method in claim 274, further comprising providing such hydro-rotor assembly drive shaft as a common feature of DC magnetics system armature.

279. The method in claim 274, further comprising providing such generator drive at a position located at the opposite axial end of the hydro-rotor assembly from the DC magnetics system.

280. The method in claim 212, further comprising providing a structural container which houses and supports the hydro rotor assembly, vanes and support infrastructure, internal mechanical support infrastructure and serving to contain and manage the fluid media.

281. The method in claim 280, further comprising:
providing a means and system of supporting a plurality of vanes (or other jet-stream thrust surfaces) around the circumference of, and in close proximity to, the rotating hydro-rotor assembly;
transferring the hydro-rotor assembly nozzle jet-stream force upon the vanes and in turn to the stationary structural case; and
causing the hydro-rotor assembly to spin or rotate about its axis.

282. The method in claim 281, further comprising:
providing such vanes positioned and shaped to efficiently process the fluid emitted from the rotating hydro-rotor assembly nozzles;
directing the vane impacting fluid away from the multiple system jet-streams so as to minimize turbulence, minimize oxygen entrapment in the fluid, avoid interference with or impinge other jet-streams; and
recycling fluid back to the propulsion system fluid reservoir.

283. The method in claim 281, further comprising providing such vanes positioned and shaped to efficiently allow the jet-streams being emitted from the hydro-rotor assembly nozzles to generate a rotational thrust force tangent to the outer diameter of the hydro-rotor assembly.

284. The method in claim 283, further comprising providing such vanes in either concave, convex or flat geometry relative to the direction of the jet-stream.

285. The method in claim 283, further comprising providing such vane position and orientation relative to the rotating hydro-rotor assembly nozzles as adjustable for optimum hydro performance.

286. The method in claim 285, further comprising providing a system and method for remotely adjusting the vane position and orientation relative to the rotating hydro-rotor assembly nozzle jet-streams vector for optimum thrust generation and dynamic hydro performance at various hydro-rotor assembly rotational speeds.

287. The method in claim 286, further comprising providing such vane position and orientation adjustment system mechanically similar to any conventional pivoting louvered systems.

288. The method in claim 286, further comprising providing such vane position and orientation adjustment system being electro-mechanical and/or servo-controlled similar to a jet/turbine engine exhaust thrust vector control system.

289. The method in claim 281, further comprising providing such vanes mounted and positioned approximately parallel to the axis of the hydro-rotor assembly.

290. The method in claim 281, further comprising providing such vanes mounted and positioned at a skewed angle relative to the axis of the hydro-rotor assembly thereby facilitating “lift” forces from the nozzle jet-streams to reduce lower shaft and/or bearing friction and system drag.

291. The method in claim 281, further comprising providing such vanes supported by a plurality of support rings or similar structure which transfer the force from the hydro-rotor assembly nozzle jet-streams to the stationary structural case.

292. The method in claim 291, further comprising providing such support rings configured with channels and fluid passages to facilitate the efficient processing of the fluid after contact with the vanes and to efficiently promote gravitational return of the fluid to the propulsion system reservoir.

293. The method in claim 291, further comprising providing such vane support infrastructure having slotted geometry which closely matches and encapsulates the cross-section of the vanes to facilitate efficient transfer of jet-steam loads to the infrastructure.

294. The method in claim 291, further comprising providing such vane support infrastructure comprising a removable locking device such as a bolt or setscrew to facilitate installation, adjustment and replacement of the vanes.

295. The method in claim 280, further comprising providing a means and system for supporting the hydro-rotor assembly and centering its axis of rotation relative to the vanes, vanes support infrastructure and structural container.

296. The method in claim 295, further comprising providing a means and system for aligning and positioning the hydro-rotor assembly nozzles relative to the vanes for optimum hydro performance.

297. The method in claim 295, further comprising providing a means and system for transferring the static and dynamic loads of the rotor-assembly to the structural case.

298. The method in claim 280, further comprising providing a means and system for managing the flow of fluid after contact with the vanes and re-circulating the fluid efficiently back to the fluid propulsion system reservoir.

299. The method in claim 298, further comprising providing a plurality of spaced gussets/diffusers located radially against the structural container outer wall, and below the plane of the bottom of the hydro-rotor assembly.

300. The method in claim 299, further comprising providing such gussets/diffusers to impede a rotational swirling of the fluid and direct it back to the fluid propulsion system reservoir, as well as provide structural integrity to the container.

301. The method in claim 299, further comprising providing such gussets/diffusers axially aligned with gussets/diffusers positioned adjacent to the vanes and/or above the top plane of the hydro-rotor assembly to function as a complimentary laminar flow system and promote efficient fluid flow back to the propulsion system reservoir.

302. The method in claim 299, further comprising providing such gussets/diffusers mounted and positioned approximately parallel to the axis of the hydro-rotor assembly.

303. The method in claim 299, further comprising providing such gussets/diffusers mounted and positioned at a skewed angle relative to the axis of the hydro-rotor assembly or incorporating a curved plane geometry.

304. The method in claim 299, further comprising providing such gussets/diffusers so located and comprising such geometry so as to efficiently direct the returning fluid flow to the fluid propulsion system reservoir in a flow path directly toward the center of the container for efficient propulsion system pick-up and circulation.

305. The method in claim 299, further comprising providing such gussets/diffusers radial positioning to further serve to bisect support bearing resonating frequency(s) and thus enabling effective distribution to and absorption by the structural container/case.

306. The method in claim 298, further comprising providing a plurality of spaced gussets/diffusers located radially between the vanes and the structural container outer wall, and approximately adjacent to the vanes.

307. The method in claim 306, further comprising providing such gussets/diffusers to impede a rotational swirling of the fluid and direct it back to the fluid propulsion system reservoir, as well as provide structural integrity to the container.

308. The method in claim 306, further comprising providing such gussets/diffusers axially aligned with gussets/diffusers positioned above the top plane and/or below the bottom plane of the hydro-rotor assembly to function as a complimentary laminar flow system and promote efficient fluid flow back to the propulsion system reservoir.

309. The method in claim 306, further comprising providing such gussets/diffusers mounted and positioned approximately parallel to the axis of the hydro-rotor assembly.

310. The method in claim 306, further comprising providing such gussets/diffusers mounted and positioned at a skewed angle relative to the axis of the hydro-rotor assembly or incorporating a curved plane geometry.

311. The method in claim 306, further comprising providing such gussets/diffusers radial positioning further serving to bisect support bearing resonating frequency(s) and thus enabling effective distribution to and absorption by the structural container/case.

312. The method in claim 298, further comprising providing a plurality of spaced gussets/diffusers located between the structural container hydro/wet section top plate and the outer wall, and located above the plane of the top of the centrifugal pump/hydro-rotor assembly.

313. The method in claim 312, further comprising providing such gussets/diffusers to impede a rotational swirling of the fluid and direct it back to the fluid propulsion system reservoir, as well as provide structural integrity to the container.

314. The method in claim 312, further comprising providing such gussets/diffusers axially aligned with the gussets/diffusers positioned adjacent to the vanes and/or below the bottom plane of the hydro-rotor assembly to function as a complimentary laminar flow system and promote efficient fluid flow back to the propulsion system reservoir.

315. The method in claim 312, further comprising providing such gussets/diffusers mounted and positioned parallel to the axis of the hydro-rotor assembly.

316. The method in claim 312, further comprising providing such gussets/diffusers mounted and positioned at a skewed angle relative to the axis of the hydro-rotor assembly or incorporating a curved plane geometry.

317. The method in claim 312, further comprising providing such gussets/diffusers radial positioning to further serve to bisect support bearing resonating frequency(s) and thus enabling effective distribution to and absorption by the structural container/case.

318. The method in claim 280, further comprising providing modular assembly provisions whereby the structural case is manufactured in stages and further providing the container with structural integrity.

319. The method in claim 318, further comprising providing a section or stage with the vanes and related support infrastructure.

320. The method in claim 319, further comprising providing fluid management passages, gussets/diffusers.

321. The method in claim 318, further comprising providing a section or stage with a container base and hydro-rotor lower shaft/bearing support infrastructure.

322. The method in claim 321, further comprising providing fluid management channels and gussets/diffusers.

323. The method in claim 321, further comprising providing a fluid sight-glass for monitoring fluid levels and flow.

324. The method in claim 321 further comprising providing a means for draining fluid, such as a removable plug or drain valve.

325. The method in claim 321, further comprising providing a means for safely lifting and maneuvering the hydropod via forklift or similar lifting device(s).

326. The method in claim 318, further comprising providing a section or stage with a hydro-rotor top shaft/bearing support infrastructure.

327. The method in claim 326, further comprising providing fluid management gussets/diffusers.

328. The method in claim 326, further comprising providing a top hydro-rotor shaft seal to prevent fluid from leaving the container.

329. The method in claim 326, further comprising providing at least one or a plurality of breather devices which allow air to enter the container to facilitate efficient gravity return of the fluid to the propulsion system reservoir yet do not allow fluid to exit the container.

330. The method in claim 318, further comprising providing a means and system for affixing and securing the sections/stages to one another.

331. The method in claim 318, further comprising providing a means and system for securing sections/stages to one another and providing leak proof joints.

332. The method in claim 318, further comprising providing a means and system for orientation, centering and rotational clocking of the various sections/stages to one another.

333. The method in claim 280, further comprising providing a means and system for lifting the completely assembled electronic hydropod.

334. The method in claim 333, further comprising providing a means and system for transferring the weight load of the complete system, or a portion thereof, to the bottom structural base plate via a plurality of rods spanning the overall container height, or point of lifting, and secured to the base plate.

335. The method in claim 333, further comprising providing a means and system for distributing the system weight load over a plurality of lifting brackets positioned about the outer diameter of the case/container.

336. The method in claim 335, further comprising providing such lifting brackets secured about the perimeter of the case to integral structural rings welded or otherwise secured to the case/container wall(s).

337. The method in claim 280, further comprising providing such outer case/container and/or infrastructure components comprised of either metal materials or synthetic materials.

338. The method in claim 212, further comprising providing such propulsion pump system comprising a screw pump, impeller, propeller or other conventional fluid/medium “processing device”.

339. The method in claim 338, further comprising providing such propulsion pump system comprising:
a cylindrical container device or similar structure which encapsulates and is oriented co-axially with the propulsion device;
preventing fluid cavitation;
producing directional laminar flow coincident with the axis of the propulsion device; and
facilitating the ability to generate fluid media pressure in the hydro-rotor assembly center cavity.

340. The method in claim 339, further comprising providing such cylindrical container device being of sufficient axial length to ensure that the propulsion device vacuum/suction/fluid inlet end of the cylindrical container is always below the level of the fluid in the reservoir during all operational modes to ensure fluid pick-up by the propulsion device.

341. The method in claim 339, further comprising providing such cylindrical container device with an inside diameter which is equal to or only slightly larger than the effective outside diameter of the propulsion device to improve the efficiency of the integrated propulsion pump system as a flow and pressure source to the hydro-rotor assembly center cavity.

342. The method in claim 339, further comprising providing such cylindrical container device comprising physical geometry in the form of concave scoops, blades, vanes or other common geometry intended to direct fluid in the reservoir into the cylindrical device inlets to improve the efficiency of the propulsion device and integrated propulsion pump system as a flow and pressure source to the hydro-rotor assembly center cavity.

343. The method in claim 342, further comprising providing such concave scoops, blades, vanes or other common geometry and corresponding holes/channels/opening being configured and aligned so as to efficiently feed fluid between the individual working blades of the propulsion device.

344. The method in claim 339, further comprising providing such cylindrical container device and propulsion device as mechanically affixed to one another so as to rotate as a single unit.

345. The method in claim 344, further comprising providing further comprising a single integrated component which incorporates all of the cylindrical container device and propulsion device features and functions.

346. The method in claim 345, further comprising providing such integrated device comprised of a commercially available, modified commercially available or specially designed pump such as but not limited to a centrifugal pump or pressure compensated centrifugal pump being integrated such that the fluid flow output of the pump flows to and pressurizes the center cavity of the hydro-rotor assembly.

347. The method in claim 346, further comprising coupling such pump to the hydro-rotor assembly such that the rotation of the hydro-rotor assembly mechanically drives the input shaft or otherwise drives the internal components of the pump.

348. The method in claim 339, further comprising providing such pump system propulsion device and cylindrical container device features and functions being integrated with the hydro-rotor assembly bottom support shaft as an integrated system.

349. The method in claim 348, further comprising providing such propulsion device, cylindrical container device and hydro-rotor assembly bottom support shaft mechanically affixed to one another so as to rotate as a single unit.

350. The method in claim 348, further comprising providing such cylindrical container device and hydro-rotor assembly bottom shaft comprised of a single integrated component.

351. The method in claim 350, further comprising providing such integrated cylindrical container/hydro-rotor assembly bottom shaft device comprising physical geometry in the form of concave scoops, blades, vanes or other common geometry intended to direct fluid in the reservoir into holes/channels/opening in the integrated device to improve the efficiency of the propulsion device and integrated propulsion pump system as a flow and pressure source to the hydro-rotor assembly center cavity.

352. The method in claim 351, further comprising providing such concave scoops, blades, vanes or other common geometry and corresponding holes/channels/opening configured and aligned so as to efficiently feed fluid between the individual working blades of the propulsion device.

353. The method in claim 338, further comprising providing such propulsion pump system co-axial to, and mechanically coupled to the hydro-rotor assembly thereby rotating as a single unit.

354. The method in claim 353, further comprising providing with such mechanical coupling a leak proof seal to improve the efficiency of the integrated propulsion pump system as a flow and pressure source to the hydro-rotor assembly center cavity.

355. The method in claim 338, further comprising providing such propulsion device functioning independent of and without mechanical integrated with the bottom hydro-rotor assembly load bearing and rotational support system and means.

356. The method in claim 212 further comprising providing an AC electrical winding system and means to initialize the rotation of the hydro-rotor and propulsion system so as to act as a centrifugal pump system utilizing thermal energy, kinetic energy, fluid dynamics and mass inertia to sustain the rotation of the hydro-rotor assembly.

357. The method in claim 356, further comprising providing the AC drive system with a plurality of poles with corresponding electrical coils, such that when a AC voltage is applied it produces a rotational force capable of developing sufficient torque to rotate the hydro-rotor assembly to a predetermined speed (RPM).

358. The method in claim 357, further comprising the AC drive system also serving to regulate the electrical output of the system driven electrical generator by controlling and regulating the rotational speed of the hydro-rotor assembly.

359. The method in claim 358, further comprising providing a means of raising and lowering the quantum of AC voltage applied to the AC drive system coils in order to produce sufficient magnetic field strengths to initiate and maintain rotation of the pump/hydro-rotor assembly at the predetermined operational speed.

360. The method in claim 359, further comprising providing a means of varying the AC voltage to achieve manipulation of the AC magnetic field so as to slow down or speed up as required the rotational speed of the hydro-rotor assembly.

361. The method in claim 360, further comprising providing a means to generate drag and reversing rotational torque sufficient to aid in bringing the hydro-rotor assembly to a halt.

362. The method in claim 359, further comprising providing an electrical generator output monitoring system coupled to or integrated with a voltage regulator circuit which automatically applies the appropriate AC voltage to the AC drive system coils in order to maintain the hydro-rotor rotational speed within a specified generator operating speed such as but not limited to 1800 rpm.

363. The method in claim 357, further comprising providing an AC power circuit comprising an AC power source.

364. The method in claim 212 further comprising providing such electrical generator as an internally integrated electrical generator being driven by a common shaft on the rotating axis of the AC drive system and/or hydro-rotor assembly.

365. The method in claim 357, further comprising providing a means and system for the AC drive system to mechanically drive the rotation of the hydro-rotor assembly in order to initiate and sustain the fluid pumping system.

366. The method in claim 365, further comprising providing a direct mechanical drive between the AC drive system armature and the hydro-rotor assembly.

367. The method in claim 366, further comprising providing the direct mechanical drive means or dive shaft as an integral part and function of the pump/hydro-rotor assembly top support shaft.

368. The method in claim 366, further comprising providing any of a variety of commercially available couplings to mechanically link the AC drive system armature to a shaft connected or integral to the top of the hydro-rotor assembly.

369. The method in claim 357, further comprising providing a drive train mechanism whereby the torque of the AC drive system armature is transferred to the hydro-rotor assembly.

370. The method in claim 357, further comprising providing a means and system for the AC drive system to mechanically drive an electrical generator in order to produce electrical power with the hydropod system.

371. The method in claim 370, further comprising providing a direct mechanical drive between the AC drive system armature and electrical generator whereby the torque of the AC drive system armature is transferred to the drive shaft of the electrical generator.

372. The method in claim 370, further comprising providing such AC drive system armature drive shaft as an integral part and function of the rotor assembly top support shaft.

373. The method in claim 370, further comprising providing any one of a variety of commercially available couplings between the AC drive system armature and electrical generator.

374. The method in claim 370, further comprising providing a drive train mechanism whereby the torque of the AC drive system armature is transferred to the drive shaft of an electrical generator.

375. The method in claim 356, further comprising:
coupling to a traditional AC electrical power grid or other available AC primary source as a means of initiating and maintaining the rotation of the hydro-rotor assembly;
providing cost effective supplemental AC power; and
lowering the load and demand upon the primary AC source.

376. The method in claim 212 further comprising providing a self-contained system capable of producing electrical power without external interface or control.

377. The method in claim 376, further comprising providing a manual command or interface via system activation with a switch, ignition key or similar device, or via any means whereby DC voltage is applied to the DC magnetics system.

378. The method in claim 356, further comprising providing a self-contained system capable of producing electrical power without external interface or control.

379. The method in claim 378, further comprising providing a manual command or interface via system activation with a switch, ignition key or similar device, or via any means whereby AC voltage is applied to the AC drive system.

380. The method in claim 376, further comprising providing an electrical relay circuit for automatic system initiation from a standby mode to facilitate automatic and/or remote turn-on/off or to serve as “auto-start” auxiliary power when a main AC feed voltage is lost or interrupted, whereafter, DC voltage is applied to the DC magnetics system.

381. The method in claim 378, further comprising providing an electrical relay circuit for automatic system initiation from a standby mode to facilitate automatic and/or remote turn-on/off or to serve as “auto-start” auxiliary power when a main AC feed voltage is lost or interrupted, whereafter, AC voltage is applied to the AC drive system.

382. The method in claim 212, further comprising providing local or remote system monitoring of key variables, conditions and outputs.

383. The method in claim 382, further comprising providing a broad range of system diagnostic devices coupled to and integrated into the electronic hydropod system for information gathering and reporting coupled to or otherwise integrated with a monitoring and diagnostic interface containing such devices as, but not limited to, digital data display, CRT monitor, LCD or other display, and various analog and digital devices, meters, gages, readouts, etc.

384. The method in claim 383, further comprising providing the systems and capabilities of monitoring system parameters including but not limited to, DC voltage in/out, DC current in/out, generator AC voltage out, generator AC current out, RPM, ambient air temperature, reservoir fluid temperature, localized fluid temperatures, barometric pressure, bearing temperatures, fluid pressures/vacuums, vibration, strain gages, etc.

385. The method in claim 383, further comprising providing the ability to monitor and trend key system parameters to facilitate predictive system required maintenance prior to unplanned interruption of service of the device.

386. The method in claim 212, further comprising providing local or remote system monitoring of key variables, conditions and outputs.

387. The method in claim 386, further comprising providing a broad range of system diagnostic devices coupled to and integrated into the electronic hydropod system for information gathering and reporting coupled to or otherwise integrated with a monitoring and diagnostic interface containing such devices as, but not limited to, digital data display, CRT monitor, LCD or other display, and various analog and digital devices, meters, gages, readouts, etc.

388. The method in claim 387, further comprising providing the systems and capabilities of monitoring system parameters including but are not limited to, AC drive voltage in/out, AC drive current in/out, generator AC voltage out, generator AC current out, RPM, ambient air temperature, reservoir fluid temperature, localized fluid temperatures, barometric pressure, bearing temperatures, fluid pressures/vacuums, vibration, strain gages, etc.

389. The method in claim 387, further comprising providing the ability to monitor and trend key system parameters to facilitate predictive system required maintenance prior to unplanned interruption of service of the device.

390. The method in claim 212, further comprising providing hard-wired or solid state circuitry for any function such as system start, system control, system monitoring and system diagnostics in place of or in conjunction with programmable or software controlled interfaces.

391. The method in claim 212, further comprising providing and coupling any number of devices in requiring a self-sustainable, environmentally friendly and economical source of power that can be derived by the output shaft of the electronic hydropod.

392. The method in claim 212, further comprising providing and coupling multiple like systems combined or networked together in series or parallel to produce electrical power in the aggregate.

393. The method in claim 376, further comprising providing and coupling an electrical relay circuit for automatic system initiation from a standby mode to facilitate automatic and/or remote turn-on/off or to serve as “auto-start” auxiliary power when a predetermined condition exists or an event occurs such as but not limited to a time of day, light level or temperature level, whereafter, DC voltage is applied to the DC magnetics drive system.

394. The method in claim 378, further comprising providing and coupling an electrical relay circuit for automatic system initiation from a standby mode to facilitate automatic and/or remote turn-on/off or to serve as “auto-start” auxiliary power when a predetermined condition exists or an event occurs such as but not limited to a time of day, light level or temperature level, whereafter, AC voltage is applied to the AC drive system.

395. The method in claim 212, further comprising:
providing a tachometer to monitor the speed of the electronic hydropod drive shaft;
providing a control logic circuit of a voltage regulator system which then interprets the information from the tachometer output;
providing a control logic circuit of a voltage regulator which then applies the appropriate DC voltage to the DC magnetic system coils in order to maintain the hydro-rotor rotational speed within a specified application operating speed;
coupling the tachometer to the electronic hydropod drive shaft to monitor the speed of the shaft;
coupling the tachometer output to the input of a voltage regulator logic circuit which then interprets the information from the tachometer output: and
coupling the voltage regulator circuit to a DC power source to automatically apply the appropriate DC voltage to the DC magnetic system coils in order to maintain the hydro-rotor rotational speed within a specified application operating speed;

396. The method in claim 212, further comprising:
providing any number of devices in furtherance of a multitude of applications requiring a self-sustainable, environmentally friendly and economical source of renewable power that can be derived by the output shaft of the electronic hydropod, rather than, and in lieu of an electrical generator; and
coupling the alternative device to the output shaft of the electronic hydropod to obtain a self-sustainable, environmentally friendly and economical source of renewable power that can be derived by the output shaft of the electronic hydropod.

397. The method in claim 396, further comprising:
providing a tachometer to monitor the speed of the electronic hydropod drive shaft;
providing a control logic circuit of a voltage regulator system which then interprets the information from the tachometer output;
providing a control logic circuit of a voltage regulator which then applies the appropriate DC voltage to the DC magnetic system coils in order to maintain the hydro-rotor rotational speed within a specified application operating speed;
coupling the tachometer to the electronic hydropod drive shaft to monitor the speed of the shaft;
coupling the tachometer output to the input of a voltage regulator logic circuit which then interprets the information from the tachometer output: and
coupling the voltage regulator circuit to a DC power source to automatically apply the appropriate DC voltage to the DC magnetic system coils in order to maintain the hydro-rotor rotational speed within a specified application operating speed.

398. The method in claim 396, further comprising:
providing an appropriate device for monitoring the output of the alternative application system being powered by the electronic hydropod drive shaft such as but not limited to, shaft speed, flow rate, pressure, etc.;
providing a control logic circuit of a voltage regulator system which then interprets the information from the alternative system monitoring device output;
providing a control logic circuit of a voltage regulator which then applies the appropriate DC voltage to the DC magnetic system coils in order to maintain the hydro-rotor rotational speed within a specified application operating speed;
coupling the alternative system monitoring device output to the input of a voltage regulator logic circuit which then interprets the information from the tachometer output; and
coupling the voltage regulator circuit to a DC power source to automatically apply the appropriate DC voltage to the DC magnetic system coils in order to maintain the hydro-rotor rotational speed within a specified application operating speed.

399. A computer program product comprising a computer storage medium having a computer program code mechanism embedded in the computer storage medium coupled to or networked with an electronic hydropod system for producing environmentally friendly renewable electrical power energy, comprising:
a) coupling a DC supply source to a DC magnetics drive system;
b) coupling the DC magnetic drive system to a hydro-rotor system with at least one hydro-rotor comprising at least one jet-stream nozzle;
c) coupling the hydro-rotor system to a fluid propulsion system forming a hydro-rotor assembly;
d) coupling the hydro-rotor system to a containment housing with a plurality of thrust producing vanes or other thrust producing surfaces, a fluid management infrastructure and a reservoir;
e) powering the rotation of the hydro-rotor assembly with coupled DC magnetic drive system to initialize a centrifugal pump system utilizing thermal energy, kinetic energy, fluid dynamics and mass inertia to sustain the rotation of the hydro-rotor assembly; and
f) coupling the hydro-rotor and/or DC magnetics drive system to at least one electrical generator to produce renewable electrical power.

400. The computer program product of claim 399, wherein the computer program code mechanism further performs the steps of:
a) providing a control interface system;
b) providing a DC voltage regulation system;
c) providing a DC voltage source;
d) providing a DC magnetics system to drive the rotation of a hydro-rotor assembly;
e) coupling the control interface system to the DC magnetics voltage regulation system;
f) coupling the DC voltage source to the DC voltage regulator system; and
g) coupling the DC voltage regulator system to DC magnetics system to drive the rotation of the electronic hydropod system.

401. The computer program product of claim 399, wherein the computer program code mechanism further performs the steps of:
providing a system parameters monitoring system: and
coupling the system parameters monitoring system to the electronic hydropod system to monitor designated operating parameters.

402. The computer program product of claim 401, wherein the computer program code mechanism further performs the steps of:
providing such system monitoring local to the electronic hydropod; and
coupling such system monitoring local to and/or otherwise directly to the electronic hydropod to monitor system variables, conditions and outputs.

403. The computer program product of claim 401, wherein the computer program code mechanism further performs the steps of:
providing such system monitoring at a remote location from the electronic hydropod; and
coupling such system monitoring at any remote location and interfacing with and communicating with the electronic hydropod system via any of a variety of available communications interfaces and systems.
to the electronic hydropod to monitor system variables, conditions and outputs.

404. The computer program product of claim 401, wherein the computer program code mechanism further performs the steps of:
providing a broad range of system diagnostic devices integrated into the electronic hydropod system for information gathering and reporting;
providing a monitoring and diagnostic interface containing such devices as, but not limited to, digital data display, CRT monitor, LCD or other display, and various analog and digital devices, meters, gages, readouts, etc.;
coupling a broad range of system diagnostic devices with the electronic hydropod system for information gathering and reporting; and
coupling a monitoring and diagnostic interface containing such devices as, but not limited to, digital data display, CRT monitor, LCD or other display, and various analog and digital devices, meters, gages, readouts, etc.

405. The computer program product of claim 401, wherein the computer program code mechanism further performs the steps of:
providing systems and devices to monitor system parameters including but are not limited to, DC voltage in/out, DC current in/out, generator AC voltage out, generator AC current out, RPM, ambient air temperature, reservoir fluid temperature, localized fluid temperatures, barometric pressure, bearing temperatures, fluid pressures/vacuums, vibration, and strain gages; and
coupling systems and devices to monitor system parameters including but are not limited to, DC voltage in/out, DC current in/out, generator AC voltage out, generator AC current out, RPM, ambient air temperature, reservoir fluid temperature, localized fluid temperatures, barometric pressure, bearing temperatures, fluid pressures/vacuums, vibration and strain gages.

406. The computer program product of claim 399, wherein the computer program code mechanism further performs the steps of:
regulating the speed of electronic hydropod system and ultimately the electrical generator output by executing appropriate commands to a voltage regulation system to vary, adjust and regulate the application of DC voltage to the DC magnetics system to maintain the desired hydro-rotor assembly and electrical generator specified speed of rotation.

407. The computer program product of claim 399, wherein the computer program code mechanism further performs the steps:
shutting down the electronic hydropod system and ultimately the electrical generator output by executing appropriate commands to a voltage regulation system to reduce and/or cease the application of DC voltage to the DC magnetics system to ultimately halt the rotation of hydro-rotor assembly and electrical generator.

408. The computer program product of claim 407, wherein the computer program code mechanism further performs the steps of:
shutting down the electronic hydropod system and ultimately the electrical generator output by executing appropriate commands to a voltage regulation system to reduce the application of DC voltage to the DC magnetic system thereby causing the magnetic fields to apply drag upon the rotation of hydro-rotor assembly and serving as a brake system to slow of halt the rotation of hydro-rotor assembly and electrical generator.

409. The computer program product of claim 399, wherein the computer program product is comprised of any one or more of a personal computer system, a workstation computer system, a laptop computer system, an embedded controller system, a programmable logic controller (PLC), a microprocessor-based system, a digital signal processor-based system, a hand held device system, a personal digital assistant (PDA) system, a wireless system, a wireless networking system, or any other common programmable device.

410. The computer program product of claim 399, wherein such computer program product:
provides input/output ports to communicate with the electronic hydropod; and
coupling the input/output ports to the electronic hydropod DC magnetics voltage regulation and diagnostic information devices.

411. The computer program product of claim 402, wherein such coupling further comprising any one of or combinations of, but not limited to direct electrical connections, thermo-coupling connections, fiber optic connections, wireless connections, network communications connections, etc.

412. The computer program product of claim 403, wherein such coupling further comprising any one of or combinations of, but not limited to direct electrical connections, thermo-coupling connections, fiber optic connections, wireless connections, network communications connections, etc.

413. The computer program product of claim 399, wherein such computer program product comprises special purpose logic devices (e.g., application specific integrated circuits (ASICSs) or configurable logic devices (e.g., generic array of logic (GAL) or re-programmable field or programmable gate arrays (FPGAs) or programmable logic controller (PLC).

414. The computer program product of claim 399, wherein such computer program product comprises a bus system coupling to a display such as a liquid crystal display (LCD), voice synthesis hardware and/or software, etc., for displaying the and/or providing information to the computer system, and include input devices such as a keyboard, cursor control (mouse, trackball, cursor direction keys, touch-screen display, optical character recognition hardware and software, etc.) for communicating information and command selection to processor.

415. The computer program product of claim 399, wherein such computer program product comprises a printer or plotter to provide printed listings of the data structures, information, etc. or any other data stored and/or generated by the computer system.

416. The computer program product of claim 399, wherein such computer program product performs a portion or all of the processing steps of the invention in response to its processor executing one or more sequences of one or more instructions contained in a memory, such as the main memory.

417. The computer program product of claim 399, wherein such computer program product comprises a bus or other communication mechanism for communicating information and a processor coupled with bus for processing the information.

418. The computer program product of claim 392, wherein such computer program product comprises code devices comprising any interpreted or executable code mechanism, including but not limited to scripts, interpreters, dynamic link libraries, Java classes, and complete executable programs.

419. The computer program product of claim 413, wherein such computer program product further comprises parts, portions or segments of the processing of the present invention being distributed for better performance, reliability, and/or cost.

420. The computer program product of claim 413, wherein such computer program product further comprises a plurality of computers or processors whereby a separate processor transmits information into the central or main processor.

421. The computer program product of claim 413, wherein such computer program product further comprises a plurality of computers or processors to execute the sequence of instructions contained in main memory.

422. The computer program product of claim 136, wherein such computer program product further comprises a system whereby the code instructions are initially carried on the computer readable media of a remote computer or processor.

423. The computer program product of claim 403, further comprising the remote computer loading the instructions for implementing all or a portion of the present invention remotely into a dynamic memory and sending the instructions over a telephone line using a modem, or any other communications network such as but not limited to over coaxial cable, fiber optic cable, various other Internet Protocol links, or a host of wireless transmission systems.

424. The computer program product of claim 417, further comprising a communications interface coupled to the bus which provides a two-way data communication coupling to a network link.

425. The computer program product of claim 424, further comprising, for example, any packet switched local area network (LAN), asymmetrical digital subscriber line (ADSL) card, an integrated services digital network (ISDN) card, or Internet Protocol (IP) based modem or PCMCIA card, wireless links, etc.
